(19) United States
(12) Patent Application Publication
(10) Pub. No.: US 2009/0070352 A1
(43) Pub. Date: Mar. 12, 2009

(54) METHOD, PROGRAM AND APPARATUS FOR MANAGEMENT OF RELATED INFORMATION

(75) Inventors: Akira KARASUDANI, Kawasaki (JP); Takashi SHINZAKI, Kawasaki (JP); Masahiro MORI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/270,327

(22) Filed: Nov. 13, 2008

Related U.S. Application Data
(62) Division of application No. 10/995,321, filed on Nov. 24, 2004.
Application No. 10/995,321 is a continuation of application No. PCT/JP02/03214, filed on Sep. 30, 2002.

(51) Int. Cl. G06F 17/00

(52) U.S. Cl. 707/100

(57) ABSTRACT

A plurality of processes executed on an operating system of a computer are monitored, the correspondence relations between each process and pieces of information processed by each process are registered in a process management table. Then, the relations between the pieces of information are extracted by analyzing what processes have been executed between the pieces of information of each process by referring to the result of the monitoring of the processes and to the process management table. The extracted relations between the pieces of information are registered into an attribute information table created for each piece of information of each process. A plural pieces of related information are displayed in a related information list based on the attribute information table of certain information being processed and pieces of related information selected in the list are accessed.

This application is a divisional of Ser. No. 10/995,321 filed Nov. 24, 2004, which is a continuation under 35 USC §111(a) of International Application PCT/JP02/03214, filed Sep. 30, 2002, the disclosures of which are incorporated herein by reference.

### TECHNICAL FIELD

The present invention relates generally to a related information management method, program and apparatus for managing related information used when documents or images, etc., are created or edited and, more particularly, to a related information management method, program and apparatus for managing closely related management information accessed when documents or images, etc., are created or edited such that the management information is automatically produced and made available for reusing.

### BACKGROUND ART

In recent years, as a result of the progress of the spread of network environments such as the Internet in addition to information apparatuses such as personal computers or PDAs, etc., users can easily create and edit documents and images and, during these operations, can access, etc. various information.

However, contrary to the fact that users can easily access a large amount of information, the load for users to manage information is also getting larger. Therefore, a mechanism for reducing the load to manage information is sought in order for the users to be able to concentrate on processing information. When a user creates or edits information or accesses information, the user often refers to a plurality of pieces of information simultaneously. For example, if a piece of information is created, another piece of information which is closely related to the information is concurrently referred. In order to access information closely related to certain information in this manner, in the present circumstances, any one of the following methods is often used.

### (1) Direct Search by User

In case of information stored, as a file, in a file system provided with a directory having a hierarchical structure, a user directly searches for related information (a related file) based on a user's memory such as “I think I stored the information in that directory” or a user's rule for creating directories (an information arrangement rule).

### (2) Use of Search Function

A storage apparatus or a network is searched with key words relating to information and related information is searched based on the result of the search.

### (3) Method Described in Japanese Patent Application Laid-Open Publication No. 1993-66986

Related information has been registered in advance and a user selects an appropriate piece of the related information from the registered content. For example, the related information has been registered in a hyperlink format and the user selects from the registered content.

However, for the conventional direct search by a user or the use of the search function, it is a problem that a user can not access easily related information because the user needs to know the configuration of the directories, needs to select appropriate information from a large amount of search results containing loosely related information, etc. Furthermore, for the method described in the Japanese Patent Application Laid-Open Publication No. 1993-66986, it is a problem that a user can not register or access easily related information because the user needs to select the pieces of information to be registered as related information, to select appropriate information from plural pieces of related information, etc.

### DISCLOSURE OF THE INVENTION

The object of the present invention is to provide a related information management method, program and apparatus that automatically register related information closely related to certain information through processes such as creation and edit of the information and that make the related information available for the user to easily and accurately use the related information when the user processes the same information later.

### (Related Information Management Based on User Processing of Single Information)

A related information management method of the present invention comprises:

a processing monitoring step of a processing monitoring unit monitoring processing of a plurality of processes executed on an operating system of a computer;

a process management table creating step of a process management information creating unit creating a process management table that registers the correspondence relation between the each of the processes and each piece of information that is processed by each of the processes;

a first processing analyzing step of a first processing analyzing unit analyzing what processings have been executed between the pieces of information of each process, while referring to the result of the monitoring of the processes and to the process management table, to extract the relations between the pieces of information; and

a second processing analyzing (attribute information table creating) step of a second processing creating unit creating for each piece of information of each process an attribute information table that registers the relation between the extracted pieces of information. According to the related information management method of the present invention described above, when a user accesses various information during creation or edit of a document or an image, the information accessed is automatically extracted as related information for the information currently processed and is registered as attribute information. Therefore, the user does not need to select the related information. Furthermore, the related information is automatically extracted based on the process by the user. Therefore, information regarded from the viewpoint of the user as being closely related can be accurately extracted.

The information processed by the process is a file or a WWW home page. The relation between the pieces of information registered in the attribute information table includes at least any one of:

pieces of information that each process simultaneously accesses;

transition of processing between pieces of information that each process simultaneously accesses;

copying of data between pieces of information that each process simultaneously accesses;

moving of data between pieces of information that each process simultaneously accesses;

reading of another piece of information into a piece of information that a process accesses; and

setting of a hyperlink to another piece of information from a piece of information that a process accesses.

The related information management method of the present invention further comprises:

a related information display step of a related information display unit displaying one (1) or plural pieces of related information (a related information list) based on the attribute information table; and

a related information access step of a related information access unit accessing apiece of information selected from the displayed piece(s) of related information.

Therefore, by displaying the related information of the information currently processed based on the attribute information method table, a user can select information that the user wants to access, from related information displayed and can easily access the related information.

The related information display step is a step for calculating the degree of relations indicating the depth of the relations for plural pieces of related information by referring to an attribute information table corresponding to the information currently processed by the process and for displaying the plural pieces of the related information in juxtaposition in order of the depth of the degree of the relation. In this manner, because the depth of the relation with the information currently processed can be obtained considering the related information registered in the past, the user can access the closely related information more accurately.

The related information management method of the present invention further comprises an attribute information registering step for registering the related information designated by a user in the attribute information table. Therefore, the user can register even the information that has not been automatically registered and is determined by the user to be necessary, as directly-related information.

The related information management method of the present invention further comprises an attribute information deleting step for deleting from the attribute information table the related information designated by a user. Therefore, the user can delete directly specific related information among the related information for the information currently processed when necessary.

The process management table creating step is executable on a multi-thread OS and includes:

a thread management table creating step of monitoring a plurality of display threads that each process executes and creating a display thread management table that registers correspondence relations between the each thread and pieces of information that each display thread displays;

a temporary process management table creating step of creating a temporary process management table that registers correspondence relations between each process and pieces of information that each process processes; and

a merging step of merging the temporary process management table and the display thread management table to create a process management table that registers correspondence relations between the processes, the threads and the pieces of information.

Thereby, for every thread at each of the process steps, the information currently processed by each of the threads can be detected and an attribute information table that registers the related information for the information currently processed can be produced.

The second processing analyzing step includes reading the attribute information table from an external storage apparatus to register the relations between the pieces of information into the attribute information table, and then writing the attribute information table into the external storage apparatus.

In this manner, the related information registered in the past is stored and is updated in a new process. Therefore, information closely related including the related information registered in the past can be selected and accessed.

The present invention provides a program for related information management. The program is operable to drive a computer to execute:

a processing monitoring step of monitoring processing of a plurality of processes executed on an operating system;

a process management table creating step of creating a process management table that registers the correspondence relation between the each of the processes and each piece of information that is processed by each of the processes;

a first processing analyzing step of analyzing what processings have been executed between the pieces of information of each process, while referring to the result of the monitoring of the processes and to the process management table, to extract the relations between the pieces of information; and

a second processing analyzing step of creating for each piece of information of each process an attribute information table that registers the relation between the extracted pieces of information.

The present invention provides a related information management apparatus. The related information management apparatus comprises:

a processing monitoring unit operable to monitor a plurality of processes executed on an operating system of a computer;

a process management table creating unit operable to create a process management table that registers correspondence relations between the processes and pieces of information that each process processes;

a first processing analyzing unit operable to analyze what processes have been executed between the pieces of information of each process, while referring to the result of the monitoring of the processes and to the process management table, to extract the relations between the pieces of information;

a second processing analyzing unit operable to create an attribute information table that registers the relations between the extracted pieces of information;

a related information display unit operable to display closely related one (1) or plural pieces of information based on the attribute information table; and

a related information accessing unit operable to access pieces of information selected from among the displayed closely related pieces of information.

Note that the details of the program and the related information management apparatus of the present invention are basically same as those of the related information management method of the present invention.

### (Related Information Management Based on User Processing of Information Group)

Furthermore, according to another embodiment of the present invention, a related information management method, program and apparatus are provided for automatically registering pieces of information closely related respectively to pieces of information in the information groups processed when a user executes a collective processing to plural pieces of information together and for making the related information available to be used by the user easily and accurately when the same information is processed later.

Thus, the related information management method of the present invention comprises:

a processing monitoring step of a processing monitoring unit monitoring user collective processing of an information group;

a first processing analyzing step of a first processing analyzing unit creating a processing target information table that registers pieces of information to be processed by the user in an information group and the content of the processing from the result of the monitoring of the processing monitoring process;

a second processing analyzing step of a second processing analyzing unit analyzing what processing has been executed on the pieces of information registered in the processing target information table, to extract relations between pieces of information;

a third processing analyzing step of a third processing analyzing unit creating an attribute information table that registers relations between the extracted pieces of information;

a related information display step of a related information display unit displaying one (1) or plural pieces of related information based on the attribute information table; and

a related information accessing step of a related information accessing unit accessing pieces of information selected from among the displayed pieces of related information.

Therefore, when the user executes processes such as moving, copying and deleting collectively to an information group including plural pieces of information, the related information of each piece of information that is the target of the process in the information groups is automatically extracted and registered as the attribute information and, when the same information is processed later, the user can access the extracted related information. Therefore, the user does not need to select the related information during the collective processing of the information group. Furthermore, because the related information is extracted based on the process by the user, the information regarded from the viewpoint of the user as being closely related can be automatically extracted. Therefore, the user does not need to search for the related information by him/herself.

The related information management method of the present invention further comprises a processing target information collecting step for checking non-target information that is not a processing target contained in the information group at the process origin and the processing destination that are the targets of the process by the user and for registering the non-target information. In this case, a third processing analyzing step is a step for extracting the relation between the non-target information at the process origin and the processing destination registered into the processing target information table, and each piece of information of the information group processed by the user and updating the attribute information table. For example, a specific piece of information in certain information group is moved into another information group, the information groups at the move origin and the move destination are checked and the information that is not the target of the process by the user is registered into the process information table. Then, when the attribute information table is created, the information that is not the target of the process in the information group at the move origin is deleted from the attribute information table for each piece of information moved that is the target of the process because the degree of the relation of the non-target information has been decreased due to the moving. On the other hand, each piece of information in the information group at the move destination is added to the attribute information table because the degree of the relation with the information moved in has been increased.

Here, at the third processing analyzing step, the attribute information table corresponding to each piece of information registered in the processing target information table is copied, moved or deleted according to the process by the user.

Furthermore, at the third processing analyzing step, the attribute information table of the related information registered in the attribute information table of each piece of information in the information group that is the target of the process by the user is checked and, when each piece of the information that is the target of the process by the user is registered in the attribute information table of the related information, the registered contents of each piece of information that is the target of the process, registered in the attribute information table of the related information is changed in response to the contents of the process (copying, moving or deleting). Therefore, by a process such as copying, moving or deleting executed to the information group by the user, even when the position of each piece of information is changed, the content of the attribute information table that registers each piece of the information matching with the content of the process can be changed and the user can refer to the related information based on the attribute information table when the user processes the same information later, similarly to the case before the process has been executed.

The processing monitoring step is a step for determining whether or not the process is a collective processing by a user to the information group based on at least either of the processing destination of each piece of information in the information group, or the difference in the time for starting up a process for each piece of information in the information group. Therefore, processes executed collectively to certain information group can be determined by analyzing the process executed to each respective piece of the information in the certain information group and, simultaneously, information contained in the information group to which the processes have been executed can be recognized.

The information to be processed by the user in the present invention contains files, folders, WWW pages or links of files. The analysis results that are registered in the attribute information table contain at least any one of copies of information, moving, deleting, link creation, link deleting and drag-and-drop.

Furthermore, the related information display step is a step for calculating the degree of relation that indicates the depth of relation about plural pieces of related information by referring to the attribute information table and for displaying the related information in juxtaposition in order of the depth of the relation degree.

The method of the present invention comprises an attribute information registering step for registering related information designated by a user into the attribute information table. Furthermore, the method of the present invention comprises an attribute information deleting step for deleting the related information designated by the user from the attribute information table.

In addition, the third processing analyzing step is a step for reading the attribute information table from the external storage apparatus and registering the relation between the information and the related information and, thereafter, writing the relation into the external storage apparatus.

The present invention provides a program for related information management directed to user collective processing of an information group. The program is operable to drive a computer to execute:

a processing monitoring step of monitoring user collective processing of an information group;

a first processing analyzing step of creating a processing target information table that registers pieces of information to be processed by the user in an information group and the content of the processing from the result of the monitoring of the processing monitoring process;

a second processing analyzing step of analyzing what processing has been executed on the pieces of information registered in the processing target information table, to extract relations between pieces of information;

a third processing analyzing step of creating an attribute information table that registers relations between the extracted pieces of information;

a related information display step of displaying one (1) or plural pieces of related information based on the attribute information table; and

a related information accessing step of accessing pieces of information selected from among the displayed pieces of related information.

The present invention provides a related information management apparatus directed to user collective processing of an information group. The related information management apparatus comprises a processing monitoring unit operable to monitor user collective processing of an information group; a first processing analyzing unit operable to create a processing target information table that registers pieces of information to be processed by the user in an information group and the content of the processing from the result of the monitoring of the processing monitoring process; a second processing analyzing unit operable to analyze what processing has been executed on the pieces of information registered in the processing target information table, to extract relations between pieces of information; a third processing analyzing unit operable to create an attribute information table that registers relations between the extracted pieces of information; a related information display unit operable to display one (1) or plural pieces of related information based on the attribute information table; and a related information accessing unit operable to access pieces of information selected from among the displayed pieces of related information.

It is to be noted that the details of the program and apparatus for related information management targeting the collective processing to the information group by the user are basically same as those of the related information management method of the present invention.

### BRIEF DESCRIPTION OF THE DRAWINGS

FIG. 1 is a block diagram of the hardware of a host computer applied with the present invention;

FIG. 2 is a block diagram of the functional composition of a first embodiment of a related information management according to the present invention;

FIG. 3 is a block diagram of the functional composition of the first embodiment continued from FIG. 2;

FIG. 4 is an illustrative diagram of a process management table of FIG. 3;

FIG. 5 is an illustrative diagram of the attribute information table of FIG. 3;

FIG. 6 is a flowchart of the basic process procedure of information management according to the present invention;

FIG. 7 is a flowchart of a related information automatic registration process according to the present invention corresponding to steps S1 to S4 of FIG. 6;

FIG. 8 is the flowchart of the related information automatic registration process continued from FIG. 7;

FIGS. 9A-9B are illustrative diagrams of a mechanism of a hooking process at a step S2 of FIG. 7;

FIG. 10 is an illustrative diagram of another mechanism of the hooking process at the step S2 of FIG. 7;

FIG. 11 is a flowchart of a process management table updating process at a step S4 of FIG. 7;

FIG. 12 is a flowchart of a related information display process at a step S5 of FIG. 7;

FIG. 13 is an illustrative diagram of a process screen during execution of an application providing display selection of the related information according to the present invention;

FIGS. 14A-14B are illustrative diagrams of a related information list based on the latest date and time of the registration of the attribute information table of information “A”;

FIG. 15 is a timing chart of a related information management process in an embodiment of FIG. 1;

FIG. 16 is a timing chart of the related information management process continued from FIG. 15;

FIG. 17 is a flowchart of a related information user registration process in the present invention;

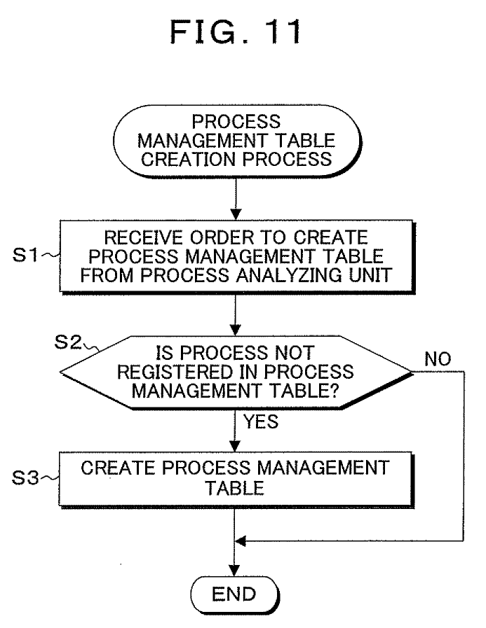

FIGS. 11A-18B show a flowchart of a related information user deleting process in the present invention;

FIG. 19 is a functional block diagram of a variation of the first embodiment of the related information management according to the present invention;

FIG. 20 is a functional block diagram of the variation of the first embodiment continued from FIG. 19;

FIG. 21 is an illustrative diagram of a display thread management table, a temporary process management table and a process management table of FIG. 20;

FIG. 22 is an illustrative diagram of a process management table updating process of FIG. 20;

FIG. 23 is a block diagram of the functional composition of a second embodiment of the related information management according to the present invention targeting a collective processing by a user;

FIG. 24 is a block diagram of the functional composition of the second embodiment continued from FIG. 23;

FIG. 25 is an illustrative diagram of a processing target information table of FIG. 24;

FIG. 26 is an illustrative diagram of an attribute information table of FIG. 24;

FIG. 27 is a flowchart of the basic process procedure of the related information management of FIGS. 23 and 24;

FIG. 28 is a flowchart of a related information automatic registering process corresponding to steps S1 to S4 of FIG. 27;

FIG. 29 is a flowchart of the related information automatic registering process continued from FIG. 28;

FIG. 30 is a flowchart of a processing target information process at a step S3 of FIG. 27;

FIG. 31 is a flowchart of a related information display process at a step S5 of FIG. 27;

FIG. 32 is an illustrative diagram of a related information list based on the latest date and time of registration of an attribute information table of information “A”;

FIG. 33 is a flowchart of a related information user registering process in the present invention;

FIG. 34A-34B show a flowchart of a related information user deleting process in the present invention;

FIG. 35 is an illustrative diagram of creation of a processing target information table for the case where pieces of information are processed collectively in the embodiment of FIGS. 23 and 24;

FIG. 36 is an illustrative diagram of creation of a processing target information table in the case where pieces of information are separately processed in the embodiment of FIGS. 23 and 24;

FIG. 37 is a flowchart of a processing target information table creating process in the case where pieces of information are respectively processed shown in FIG. 36;

FIG. 38 is an illustrative diagram of a changing process of the attribute information table accompanied by the collective processing of a file in the embodiment of FIGS. 23 and 24;

FIG. 39 is a flowchart of an updating process of the attribute information table of FIG. 38;

FIG. 40 is a flowchart of the updating process continued from FIG. 38;

FIG. 41 is an illustrative diagram of the changing process for the attribute information table of the related information accompanied by the collective processing of files in the embodiment of FIGS. 23 and 24;

FIG. 42 is an illustrative diagram of the changing process for the attribute information table continued from FIG. 41;

FIG. 43 is a flowchart of an attribute information table updating process of the related information of FIGS. 41 and 42;

FIG. 44 is a flowchart of the attribute information table updating process continued from FIG. 43;

FIG. 45 is an illustrative diagram for the case where the related information management of the present invention is applied to a network; and

FIG. 46 is an illustrative diagram for the case where a user processing targeted to be monitored in the present invention is executed as an operation to a shortcut.

### BEST MODE FOR CARRYING THE INVENTION

### Related Information Management Based on User Processing of Single Information

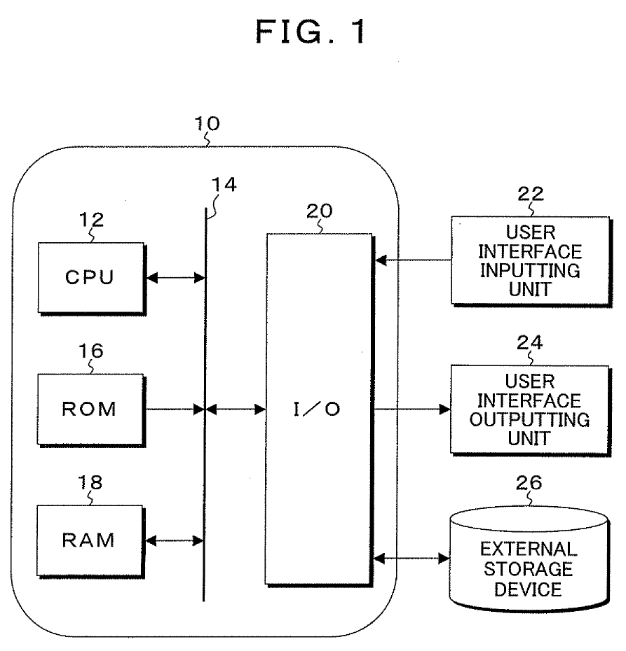

FIG. 1 is a block diagram of the hardware configuration of a host computer applied with a program for related information management of the present invention. In FIG. 1, a host computer 10 comprises a CPU 12, a bus 14, an ROM 16, an RAM 18 and an inputting/outputting unit 20, and is connected with a user interface inputting unit 22, a user interface outputting unit 24 and an external storage apparatus 26 through the input/output unit 20. The user interface inputting unit 22 includes a keyboard, a mouse, etc. and the user interface outputting unit 24 includes a display, a printer and, in addition, a communication line to the Internet, etc. The external storage apparatus 26 usually employs a hard disk drive. The CPU 12 controls the ROM 16, the RAM 18, the inputting/outputting unit 20, the user interface inputting unit 22, the user interface outputting unit 24 and the external storage apparatus 26. The ROM 16 and the RAM 18 are internal storage devices for executing programs. The inputting/outputting unit 20 executes inputting and outputting of data with the user interface inputting unit 22, the user interface outputting unit 24 and the external storage apparatus 26 and, in addition, other external apparatuses. The CPU 12 executes processes for related information management of the present invention by executing a program having been stored in the ROM 16 in advance or a program read from the external storage apparatus 26 into the RAM. A program executed by the host computer 10 is a program for the related information management according to the present invention as an application program in addition to an operating system such as Windows XP (a registered trademark) of Microsoft, Linux, etc.

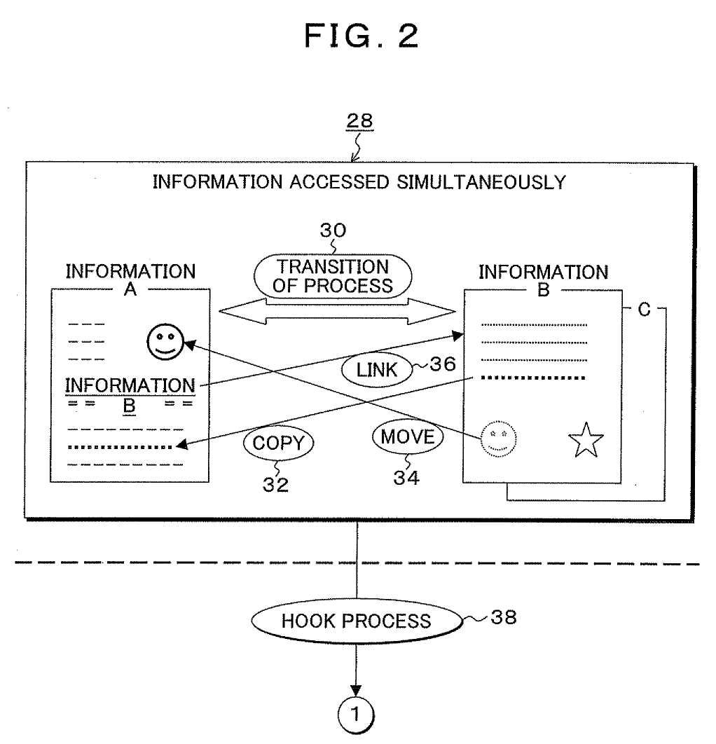

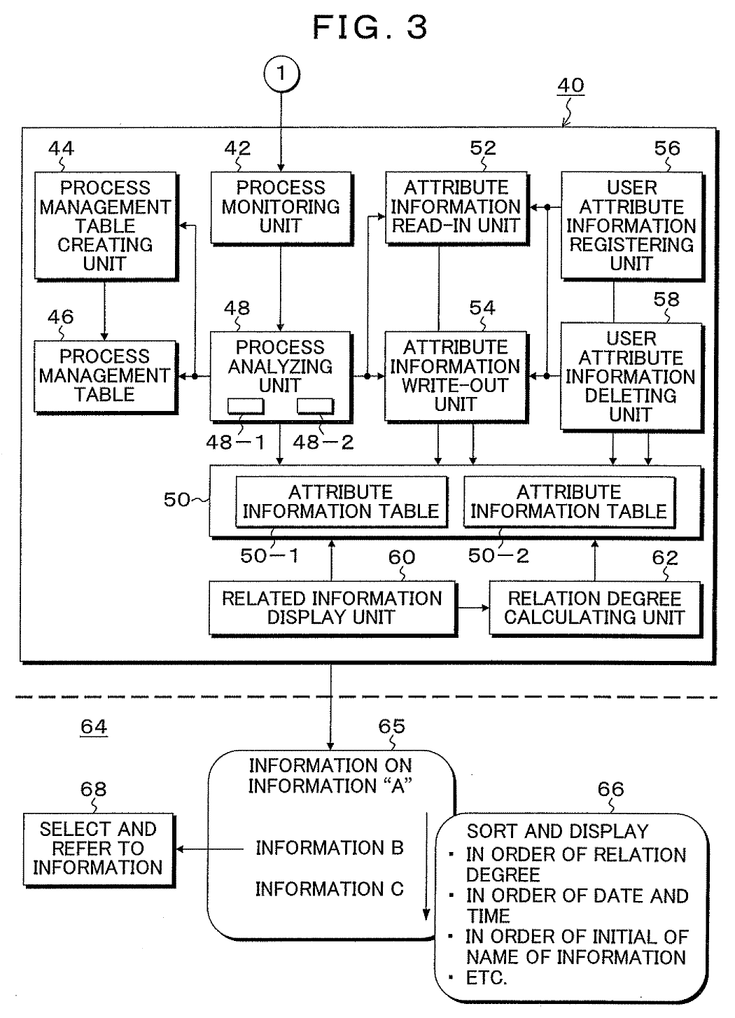

FIGS. 2 and 3 are block diagrams of the functional composition of a first embodiment of the related information management of the present invention. In FIGS. 2 and 3, a user interface 28 is provided to a related information management unit 40 provided by the present invention and a user executes an operation such as creation or edit of a document or an image on the user interface 28. More specifically, for example, taking an example of Windows XP (a registered trademark) of Microsoft, creation or edit of a document is executed by accessing a file using an application such as Word (a registered trademark), Excel (a registered trademark), etc. and, for example, an operation is executed for shifting to Excel (a registered trademark) during creation of a document by Word (a registered trademark) and using necessary data. In this example, pieces of information A, B and C handled respectively by different applications are shown and processes such as transition of a process 30, copying of data 32, moving of data 34, linking 36, etc. are executed by the operation by the user when necessary. The related information management unit 40 is provided with a processing monitoring unit 42, a process management table creating unit 44, a process management table 46, a process analyzing unit 48, an attribute information table 50, an attribute information read-in unit 52, an attribute information write-out unit 54, a user attribute information registering unit 56, a user attribute information deleting unit 58, a related information display unit 60 and a relation degree calculating unit 62. When a user executes a predetermined process to certain information on the user interface 28, the processing monitoring unit 42 detects this process and delivers the detected result to the process analyzing unit 48. The process for this processing monitoring unit 42 to monitor a predetermined process and to detect that process is known as “hooking of a process” and, in this embodiment, hooks the processes listed as follows.

(1) To start and end an access to information;
(2) To link to another piece of information
(3) To insert another piece of information into a piece of information
(4) To make transition of process between process steps or threads;
(5) To copy data between processes or threads;
(6) To move data between processes or threads; and
(7) To create a new process or a thread.

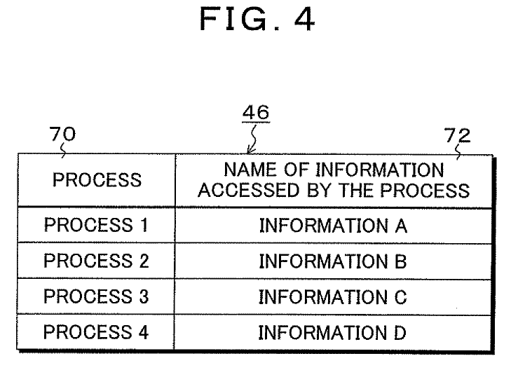

Information hooked in the processing monitoring unit 42 includes files, homepages on WWW, etc. When the process analyzing unit 48 has received data relating to a hooked process from the processing monitoring unit 42, the unit 48 determines whether or not the information to which the process has been executed is new information using the function as a first processing analyzing unit 48-1. For example, the process analyzing unit 48 determines whether or not the information to which the process has been executed is new information based on whether or not the information has been registered by referring to the process management table 46. Here, in the process management table 46, correspondence relation between the on-going process and the information accessed by the process is registered. The registration into this process management table 46 is executed by the process management table creating unit 44. The process management table creating unit 44 learns the on-going process or the information accessed by each process through the process analyzing unit 48 and creates and updates, etc. the process management table 46 into which the correspondence relation between the process and the information is registered. This process management table 46 has the content shown in FIG. 4. In FIG. 4, the process management table 46 has an item of “Name of Information Accessed by the Process” 72 and, in this example, information “A” is registered for “Process 1”, information B is registered for “Process 2”, information C is registered for “Process 3” and information D is further registered for “Process 4”.

When the process analyzing unit 48 determines the information to which the hooked process has been executed to be new information by referring to the process management table 46, the unit 48 orders the process management table creating unit 44 to update the process management table 46. Receiving this order, the process management table creating unit 44 registers the correspondence relation between the process and the new information into the process management table 46 based on the data relating to the hooked process. Then, the process analyzing unit 48 creates respectively for information of each process an attribute information table that has registered the relations between extracted pieces of information by the function as a second processing analyzing apparatus 48-2. Therefore, the unit 48 orders the attribute information read-in unit 52 to read an attribute information table corresponding to the new information to which the process has been executed. If an attribute information table of the new information is present in the external storage apparatus 26 of FIG. 1, the attribute information read-in unit 52 reads the attribute information table from the external storage apparatus and displays the table in the attribute information table storing unit 50. If any attribute information table of the new information is not present in the external storage apparatus 26, the process analyzing unit 48 creates an attribute information table of the new information in the attribute information table storage unit 50.

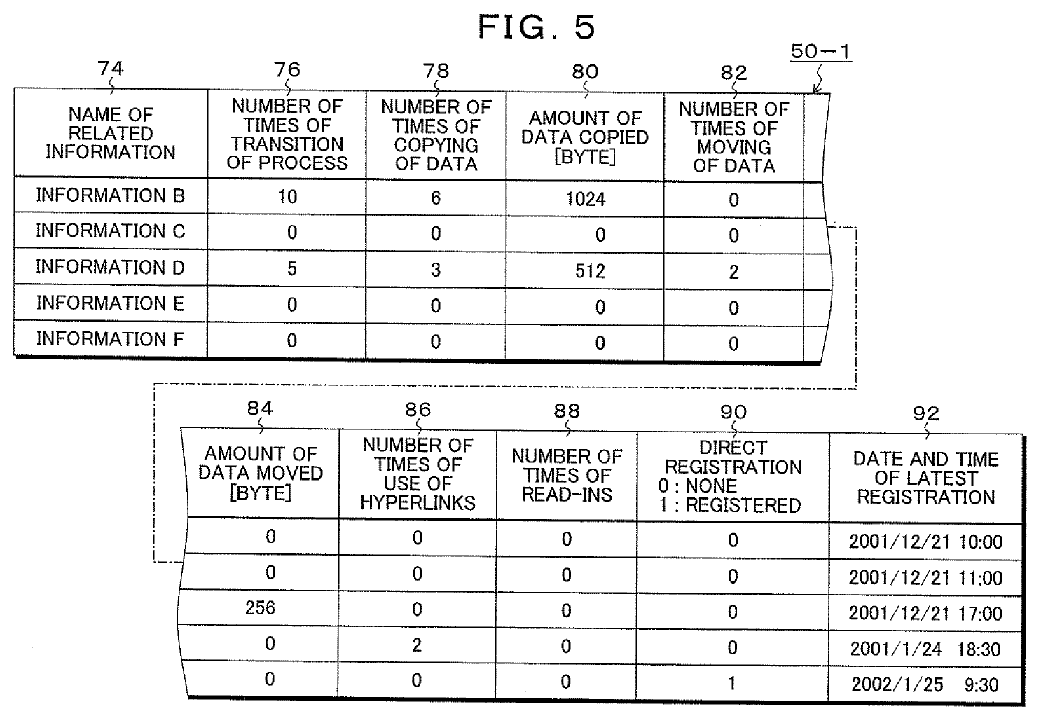

Here, taking an example of the state where an attribute information table 50-1 for the information A is present in the attribute information table storage unit 50 and the correspondence relation between a process and information as shown in FIG. 2 has been registered in the process management table 46, the attribute information table 50-1 has the content of the table of FIG. 5. In FIG. 5, pieces of related information B, C, D, E and F relating to the information A are registered. That is, the pieces of information B to F are registered as related information into the item of “Name of Related Information” 74 in the attribute information table 50-1. The following pieces of information are registered as related information for certain information corresponding to such attribute information table.

(1) Other information accessed simultaneously with the certain information;
(2) Other information to which a process has made transition from the certain information;
(3) Other information that has copied data from the certain information;
(4) Other information that has created a hyperlink with the certain information;
(5) Other information having been inserted into the certain information; and
(6) Information that a user has directly registered into an attribute information table.

For example, in the attribute information table 50-1, the information B is information that has copied data from the information A. The information C is information accessed simultaneously with the information A. The information D is information that has copied data and moved in data from the information A. The information E is information that has created a hyperlink with the information A. Moreover, the information F is information that a user has directly registered into an attribute information table. Here, as to the registration of the related information into the attribute information table, the related information is registered into the attribute information table 50-1 of information A that is the process origin and is also registered simultaneously into the attribute information table 50-2 of other information that is the processing destination. For example, when data are copied from the information A to the information B, the information B is recorded into the item of “Name of Related Information” 74 in the attribute information table 50-1 for the information A, and the information A is registered simultaneously in the item of “Name of Related Information” 74 of the attribute information table 50-2 of the information B. Furthermore, the following pieces of attribute information are registered in an attribute information table of certain information in addition to the related information.

(1) The number of times of process transitions;
(2) The number of times of copying of data and the amount of data copied;
(3) The number of times of moving of data and the amount of data moved;
(4) The number of times of use of hyperlinks;
(5) The number of times of read-ins (and the amount of data read in if necessary);
(6) Flag indicating that a user has directly registered into an attribute information table; and
(7) The latest date and time of the registration of attribute information.

Corresponding to the above, in the attribute information table 50-1 of the information A of FIG. 5, following the “Name of Related Information” 74, “Number of Times of Process Transitions” 76, “Number of Times of Copying of Data” 78, “Amount of DataCopied” 80, “Number of Times of Moving of Data” 82, “Amount of Data Moved” 84, “Number of Times of Use of Hyperlinks” 86, “Number of Times of Read-ins” 88, “Direct Registration Flag” 90 and “The Latest Date and Time of the Registration” 92 are provided as attribute items. Here, a registration item in the attribute information table, the “Number of Times of Process Transitions” 76 represents the number of times of transition of widows, etc. in the case for an OS with a window system such as Windows XP (a registered trademark) of Microsoft, Linux, etc. For example, Word (a registered trade mark) and Excel (a registered trademark) are used on Windows XP (a registered trademark), the item represents the number of times of transition of the windows from Word (a registered trade mark) to Excel (a registered trademark) and vice versa. In addition, in the case where a name of related information has been already registered in the attribute information table, registration is executed by overwriting the corresponding information.

Referring again to FIG. 3, when an attribute information table corresponding to the information to which a process is executed is present in the attribute information table storing unit 50 during writing or creation of another attribute information table by the process analyzing unit 48, the attribute information table already present is updated. For example, the case where the information A has been accessed at the time when an access to the information B is started on the user interface 28 can be listed. In this case, the attribute information table 50-1 of the information A is already present and, after reading in or creation of the attribute information table of the information B, the related information to the attribute information table 50-2 of the information B and the related information to the attribute information table 50-1 of the information A are updated. That is, attribute data relating to the related information A are registered into the attribute information table 50-2 of the information B and attribute data relating to the related information B are registered into the attribute information table 50-1 for the information A. On the other hand, if the process analyzing unit 48 determines that the information to which the process has been executed is not the new information nor the end of the access to the information, from the data relating to the hooked process received from the processing monitoring unit 42, the process analyzing unit 48 updates the attribute information table of the information to which the process has been executed and the attribute information table of the related information related to the information to which the process has been executed. For example, in the case where a user makes a transition of a process from the information B to the information A, the attribute information table 50-2 of the information B and the attribute information table 50-1 of the related information A related to the information B are updated. That is, the attribute data relating to the related information A are registered into the attribute information table 50-2 of the information B and the attribute data relating to the related information B are registered into the attribute information table 50-1 of the information A. Furthermore, if the process analyzing unit 48 determines that the process hooked by the processing monitoring unit 42 had ended the access to the information, the process analyzing unit 48 causes the process management table creating unit 44 to delete from the process management table 46 the registered data representing the correspondence relation between the process having ended and the information to which the process having been accessed. Furthermore, the process analyzing unit 48 orders the attribute information write-out unit 54 to write the attribute information table of the information deleted from the process management table 46 out into the external storage apparatus.

The attribute information registering unit 56 registers directly the related information by operation of a user into the attribute information table of the information accessed on the user interface 28. The attribute information deleting unit 58 deletes the related information designated by the operation of a user from the attribute information table of the information currently accessed on the user interface 28. The related information display unit 60 displays the related information of the information currently accessed as a related information list 65 like, for example, a user interface 64, based on the content of the attribute information table of the information currently accessed on the user interface 28. For example, the pieces of information B and C are displayed in the related information list. The display of plural pieces of related information in the related information list 65 is displayed in the order sorted according to a related information display rule 66. As the related information display rule 66, the following can be listed.

### (1) Degree of Relation

The degrees of relation indicating the depths of relations are calculated using attribute data of the attribute information table, are sorted in the descending or ascending order of the degree of relation and are displayed. The degree of relation is calculated in the relation degree calculating unit 62. For example, the degree of relation is calculated by multiplying the value of each attribute item in the attribute information table of FIG. 4 respectively by a weight and summing up the products.

### (2) Date and Time

The latest dates and times of day at which pieces of the related information or the attribute data are registered into the attribute information table are sorted and displayed in the descending or the ascending order.

### (3) Name of Related Information

Names of pieces of related information of an attribute information table are sorted in the descending or the ascending order and displayed.

In the pieces of related information list 65 on the user interface 64 of FIG. 3, the pieces of related information B and C are displayed as information related to the information A in the ascending order sorted by the names of related information.

Selected related information is referred to for the pieces of related information displayed in the related information list 65 at the user interface 64 by a related information access 68 for the user to select and access any one piece of the related information.

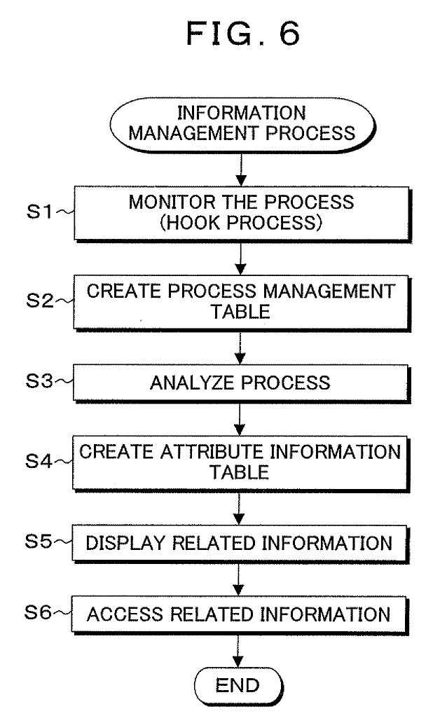

FIG. 6 is a flowchart of the basic process procedure of the related information management process of the present invention according to the embodiment of FIGS. 2 and 3. In FIG. 6, first, at a step S1, processing monitoring is executed for monitoring the execution of a process to information by user. When the user executes the process to the information, the process is hooked, at a step S2, a process management table is created. As shown in FIG. 4, in this creation of the process management table, the corresponding relation between the process and the information is registered into the process management table 46. Then, at a step S3, what type of process has been executed between the pieces of information of individual processes is analyzed by referring to the monitoring result of the process of the step S1 and the process management table 46 created at the step S2, and the relation between the pieces of information is extracted. Then, at a step S4, an attribute information table is created and the relation between the pieces of information is registered into the created table. More specifically, the related information is registered into the attribute information table that is the process origin and the related information is simultaneously registered into the attribute information table of the information that is the processing destination. Then, at a step S5, the related information is displayed based on the attribute information table corresponding to the information currently accessed by the user. Furthermore, at Step S6, the related information can be accessed by selecting appropriate piece of the related information among the displayed pieces of related information.

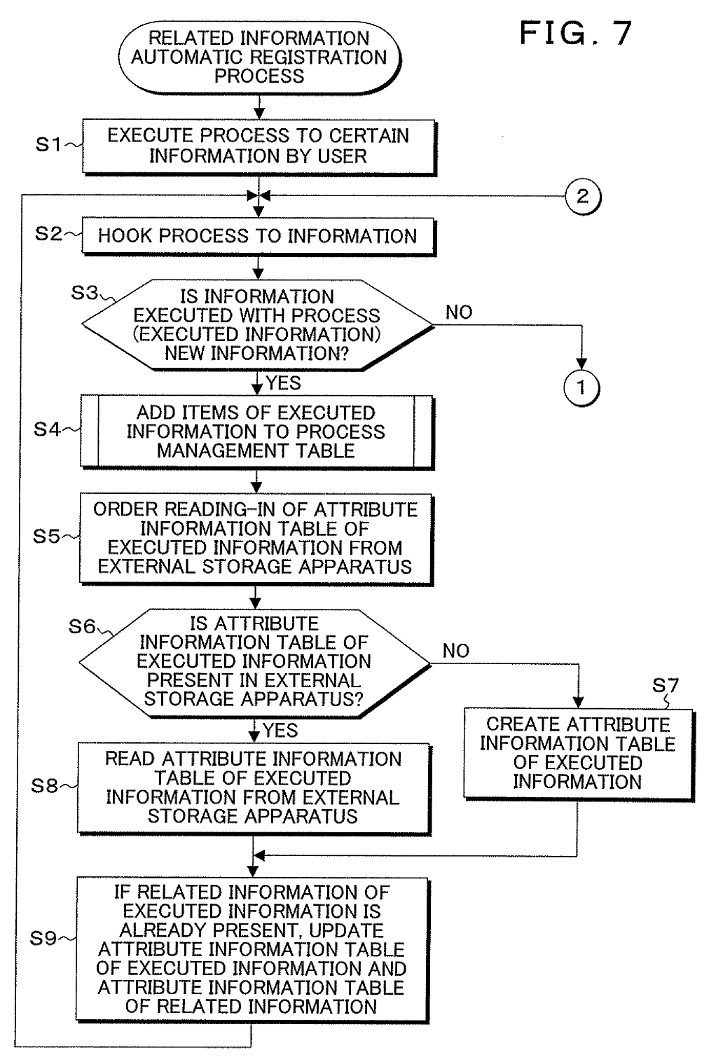

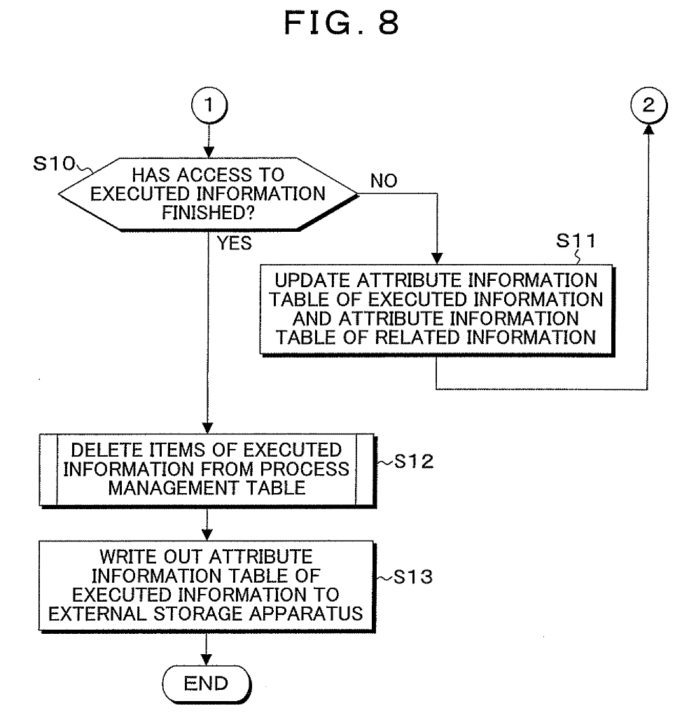

FIGS. 7 and 8 together show a flowchart of the related information automatic registering process according to the present invention corresponding to the steps S1 to S4 of FIG. 6. In this related information automatic registering process, when a user executes a process to certain information at a step S1, the process to the information by the user is hooked and data relating to the hooked process is delivered to the process analyzing unit 48 by the processing monitoring unit 42 in a step S2. Receiving this, the process analyzing unit 48 checks whether or not the information to which the process has been executed is new information at a step S3. More specifically, the process management table 46 is referred to and the information is determined to be new information if the information is not registered in the process management table 46, and the procedure advances to Step S4. At a step S4, a process for creating a process management table is executed by an order to the process management table creating unit 44 and the combination of the process and the information is registered additionally into the process management table 46. Then, at a step S5, reading in of the attribute information table of the information to which the process has been executed, from the external storage apparatus 26 is ordered. Following this order of reading in at a step S6, whether or not the attribute information table of the information to which the process has been executed is present in the external storage apparatus is checked and, if not, at a step S7, an attribute information table of the information to which the process has been executed is newly created. If the attribute information table is present in the external storage apparatus, at a step S8, the attribute information table of the information to which the process has been executed is read in from the external storage apparatus. Then, at a step S9, when related information related to the information to which the process has been executed is already present, the attribute information table of the information to which the process has been executed and the attribute information table of the related information are respectively updated. For example, assuming that the information to which the process has been executed is the information B and the related information A, attribute data relating to the information B are registered into the attribute information table 50-1 of the information B to which the process has been executed and attribute data relating to the information B are registered into the attribute information table 50-1 of the related information table A. On the other hand, if the information to which the process has been executed is not new information at the step S3, the procedure advances to a step S10 and whether or not the access to the information to which the process has been executed has ended is checked. If the access has not been ended, the procedure advances to a step S11 and the attribute information table of the information to which the process has been executed and the attribute information table of the related information of the above information are respectively updated. If the access to the information to which the process has been executed has ended at a step S10, the procedure advances to a step S12 and the items for the information to which the process has been executed are deleted from the process management table. Thereafter, at a step S13, the attribute information table of the information to which the process has been executed is written into the external storage apparatus 26 and the series of related information automatic registering process is ended.

Here, the details of the hooking process at the step S2 of FIG. 7 will be described. In order to realize hooking of a process on an OS such as Windows (a registered trademark), etc., a processing monitoring function that is a function to monitor a process is arranged to be evoked when a process that is desired to be monitored has been evoked. This method includes the following two types.

(1) A method of rewriting the address of the function, and
(2) A method by a call-back function.

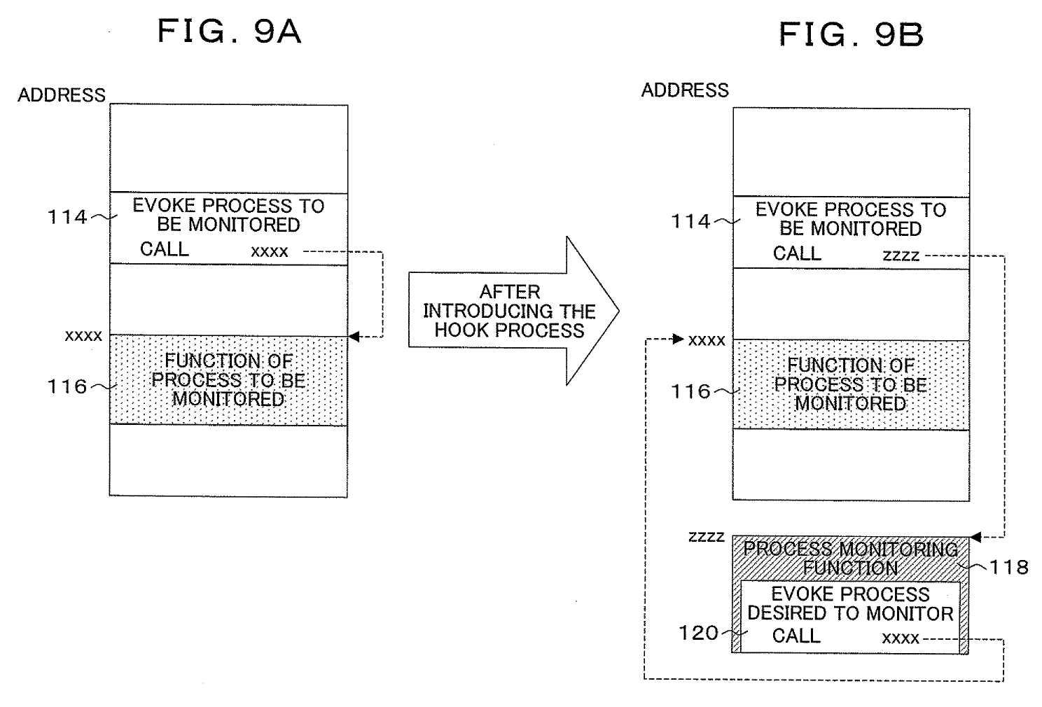

FIGS. 9A and 9B together show a method of realizing the hooking process for rewriting the address of the function. FIG. 9A is a memory map before a hooking process is introduced and a function 116 of the process to be monitored having an address, xxxx can be evoked using a evoking command “CALL xxxx” of the process to be monitored. FIG. 9B is a memory map after the hooking process has been introduced according to the method of rewriting the address of the function. That is, a processing monitoring function 118 is prepared at an address zzzz and the address of the evoking command 114 is changed to “CALL zzzz” that has been changed according to the address zzz of the processing monitoring function 118. Then, “CALL xxxx” is provided to the processing monitoring function 118 as an evoking command 120 for the function 16 of the process to be monitored. When the evoking command 114 for the process to be monitored is executed by such an address rewriting of the function shown in FIG. 9B, though the function 116 of the process to be monitored is evoked before the introduction of the hooking process, the processing monitoring function 118 is evoked after the introduction of the hooking process. This processing monitoring function 118 evokes the function 116 of the process to be monitored after delivering the content of the process to be monitored to the process analyzing unit 48 of FIG. 3.

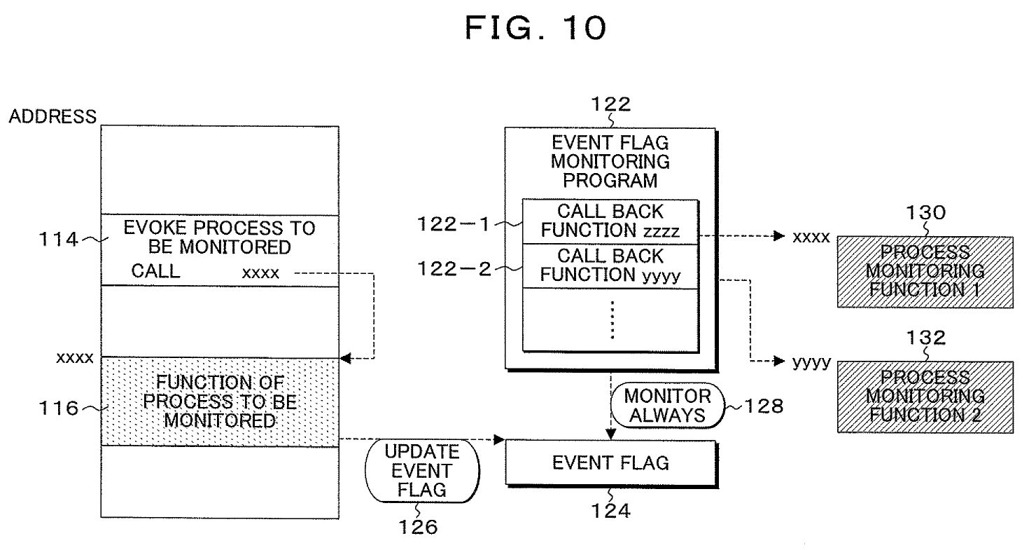

FIG. 10 shows a method using the call back function as another method of realizing the hooking process. This method of the hooking process uses an event flag 124 and call back functions 122-1, 122-2, etc. The event flag 124 is a flag of which the state is varied when a process is evoked. In the case of the present invention, when the function 16 of the process to be monitored is evoked by executing “CALL xxxx” that is the evoking command 114 of the process to be monitored, the evoked function 116 of the process to be monitored varies the state of the event flag 124. The state of the event flag 124 is monitored by an event flag monitoring program 122. When the state of the event flag 124 has been varied, the event flag monitoring program 122 evokes the call back function registered in advance responding to the varied state. The relation is described as follows: the interruption by the hardware exactly corresponds to the event flag 124 and the function registered in an interruption vector corresponds to the call back function. For the hooking process of the present invention, a flag changing function is provided to the function 116 of the process to be monitored such that the even flag 124 is changed when the process to be monitored that is desired to be hooked is evoked. Furthermore, when processing monitoring functions 130 and 132 are retained respectively at xxxx and yyyy as the processing monitoring functions, each address of the processing monitoring functions 130 and 132 is registered like the call back functions 122-1 and 122-2 in the event flag monitoring program 122. When the function 116 of the process to be monitored is evoked by executing “CALL xxxx” of the evoking command 114 of the process to be monitored by this mechanism, the state of the event flag 124 is varied in response to the process of event flag changing 126 and the processing monitoring function 130 is evoked by the event flag monitoring program 122 using the call back function 122-1. The process checks the content of the process to be monitored and delivers to the process analyzing unit 48.

FIG. 11 is a flowchart of the process management table creating process at the step S2 of FIG. 6 and of a creating process of a process management table for the case where a process and information to which user accesses corresponds to each other one to one. First, at a step S1, when the process management table creating unit 44 has received an update order of the process management table 46 from the process analyzing unit 48, then, at a step S2, whether or not the process is a process not registered in the process management table 46 from data relating to the hooked process is confirmed. Here, the data relating to the hooked process provided from the process analyzing unit 48 includes identifying information for determining uniquely the target process of the hooked process and the name of information currently accessed by this process. If the process is a process already registered in the process management table 46 at a step S2, the creating process of the process management table is ended. If the process is a process not registered, the procedure advances to a step S3 and the process management table 46 is updated by registering the combination of the process and the information accessed by this process into the process management table.

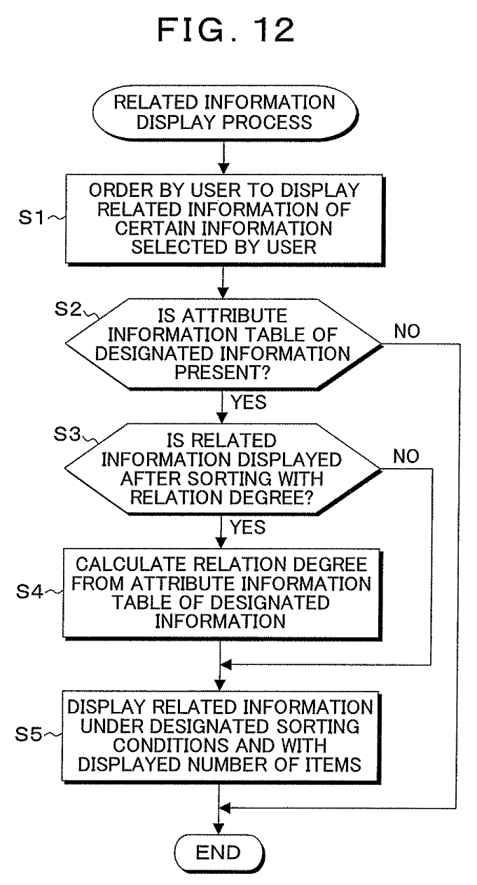

FIG. 12 is a flowchart of the related information display process at the step S5 of FIG. 6. In this related information display process, when a user selects and designates a display of the related information of certain information at a step S1, whether or not the attribute information table of the designated information is present is checked at a step S2. If the attribute information table is present, whether or not the pieces of related information of the attribute information table are sorted and displayed in order of degree of relation is checked at a step S3. If sorting and displaying in order of degree of relation are designated, the procedure advances to a step S4 and degree of relation indicating the depth of the relation with each piece of the related information is calculated from the attribute information table of the designated information. Finally, at a step S5, the pieces of related information is displayed under the designated sorting conditions and the display conditions. These sorting conditions are three of the degree of relation, the date and time and the name of the related information shown in the related information display rule 66 of FIG. 3. Here, in the related information display process of FIG. 12, the information that is the target for displaying the related information is designated, for example, as follows. The related information corresponding to the information currently processed by a user is displayed. For example, Word (a registered trademark) and Excel (a registered trademark) are currently used on Windows XP (a registered trademark) and editing is being executed on Word (a registered trademark), the related information of the file being edited on Word (a registered trademark) is displayed.

When the related information is displayed, of which information the related information is displayed is designated directly by a user. For example, a file is designated by a file referencing dialogue on Windows XP (a registered trademark) and the related information of the file is displayed.

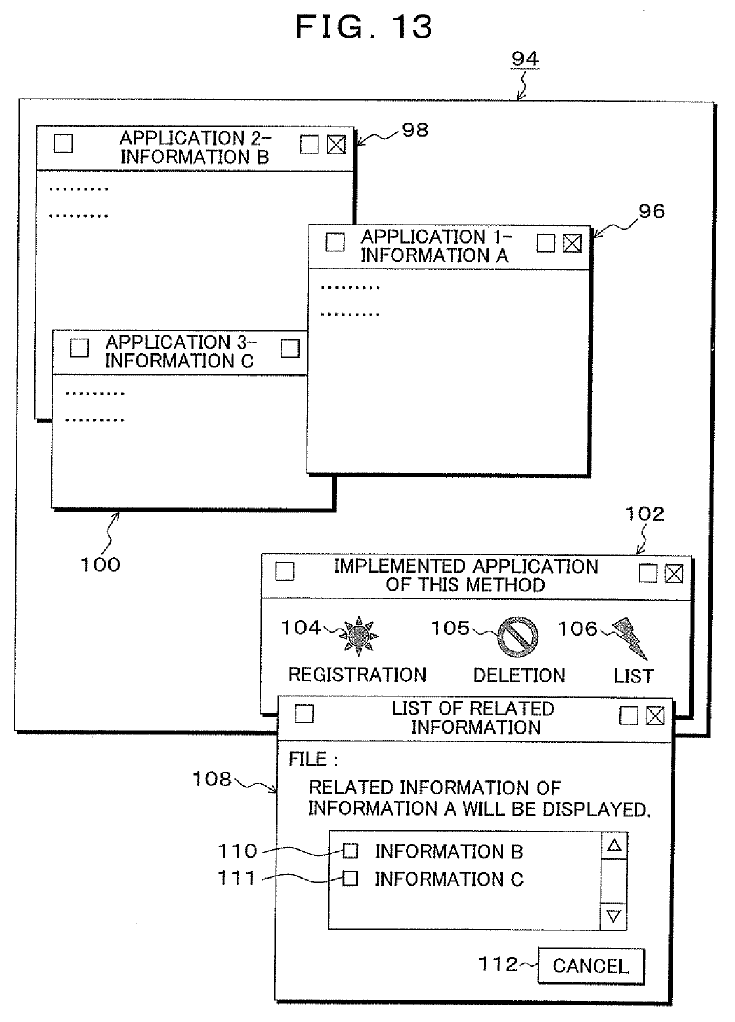

FIG. 13 shows a specific example of display of the related information corresponding to the information currently processes by a user. In FIG. 13, three windows of a window 96 of the information A of an application 1, a window 98 of the information B of an application 2 and a window 100 of the information C of an application 3 are present in a work screen 94, and currently a process is being processed by a user on the window 96 of the information A of the application 1. In such a case, a related information menu window 102 of a implemented application realizing the related information management of the present invention is displayed lower right of the work screen 94. In this related information menu window 102, a registration menu button 104, a deleting menu button 105 and a list menu button 106 are provided. When the related information is desired to be displayed, a related information list 108 is displayed by clicking the list menu button 106 with a mouse, etc. A message, “Related information of the information A is displayed.” is displayed in the related information list 108, the pieces of related information B and C are displayed under the message and, in addition, checkboxes 110 and 111 are provided to access. Therefore, when, for example, the information C is referred to by the user from the related information list, the information C can be displayed on the work screen 94 by clicking the check box 111 with the mouse.

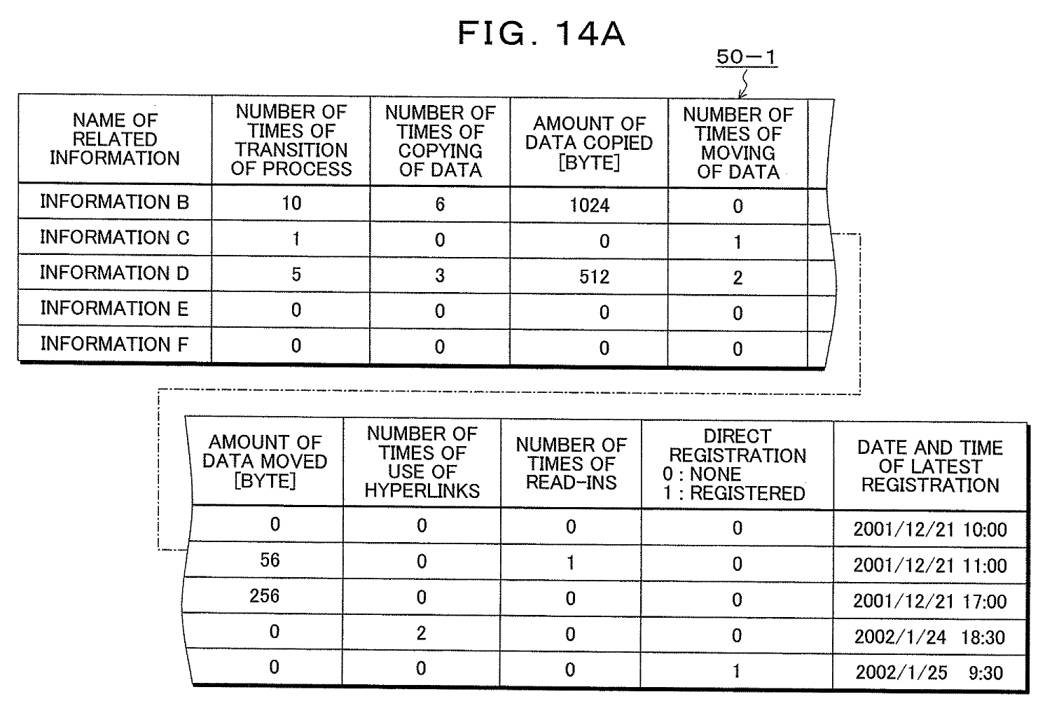

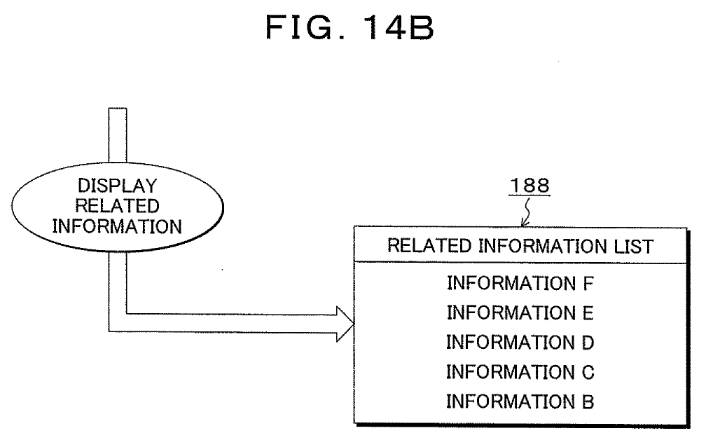

FIG. 14 shows the attribute information table 50-1 of the information A that is the target of the related information display process of FIG. 12 and a related information list 188 displayed based on the related information display process. This related information list 188 is sorted and displayed, for example, by the latest date and time of registration of the attribute information table 50-1 of the information A in the ascending order. That is, the pieces of information of registration date and time are displayed in the related information list 188 after being sorted in order of newer pieces of information F, E, D, C, B. Surely, as the related information display, in addition to this, needless to say that display by sorting by name of the related information or sorting by the degree of relation obtained by multiplying the attribute data from the number of times of document transition to the number of times of read-ins by predetermined weights and summing up the products may be possible.

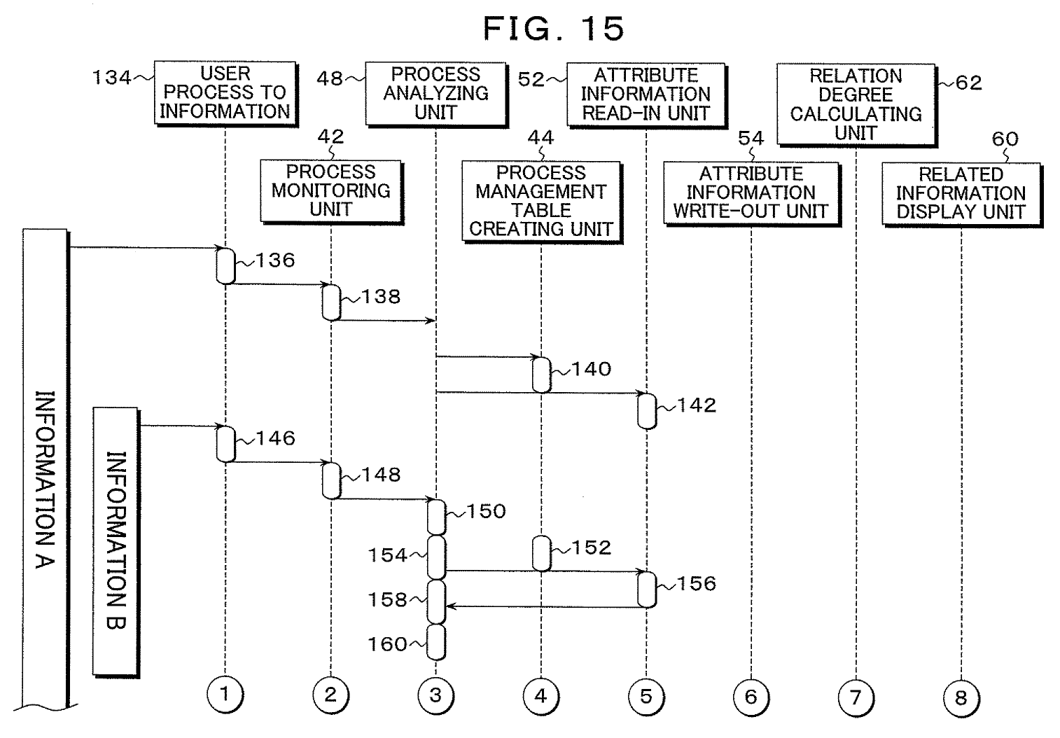

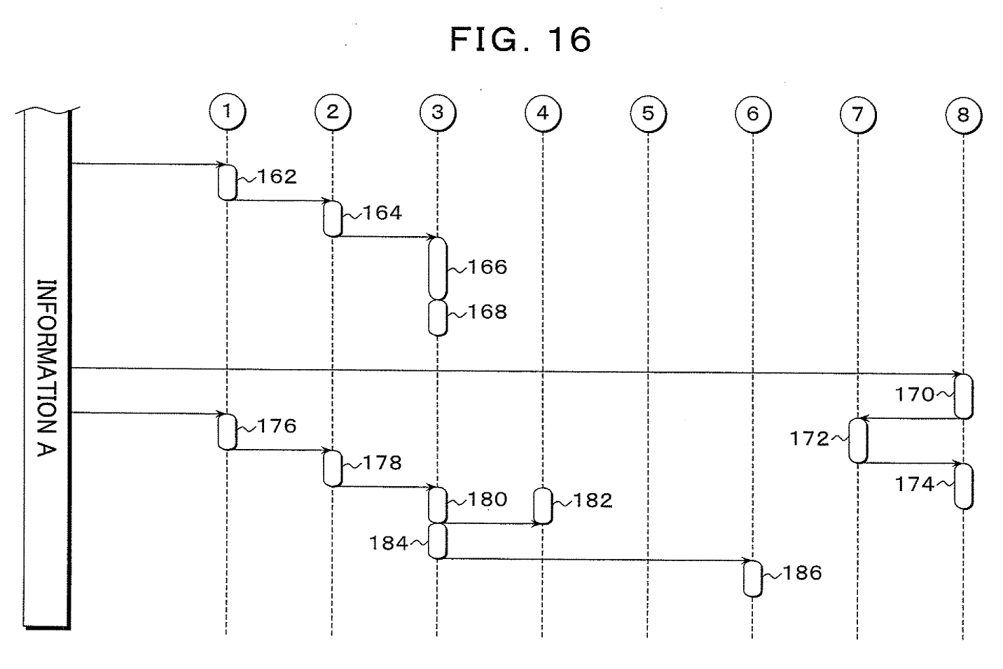

FIGS. 15 and 16 are timing charts of the whole process of the related information management process according to the flowchart of FIG. 6. In FIGS. 15 and 16, assuming that access by a user to the information A has been started at a process 136 as a user process 134 to information, the processing monitoring unit 42 hooks the start of the access to the information A as a process 138 and delivers the data accompanied by the hooking to the process analyzing unit 48. Receiving the data, the process analyzing unit 48 orders the process management table creating unit 44 to update and the process management table 46 adds items of the information A, that is, the combination of the process and the information A to the process management table 46 as a process 140. Then, the process analyzing unit 48 orders the attribute information read-in unit 52 to read in the attribute information table of the information A and reading in of the attribute information table of the information A is executed in a process 142. Assuming that, during this process of the user to the information A, an access to the information B has been started by the user in a process 146 as a user process 134, the processing monitoring unit 42 hooks the start of the access to the information B as a process 148, and delivers the data accompanied by the hooking to the process analyzing unit 48. The process analyzing unit 48 orders updating of the process management table to the process management table creating unit 44 by a process 150, and registers additionally the items of the information B, that is, the combination of the process and the information B to the process management table 46 in a process 152. Furthermore, the process analyzing unit 48 orders the attribute information read-in unit 52 to read in the attribute information table of the information B by a process 154. Then, reading in of the attribute information table of the information B is executed as a process 136 and the procedure is delivered to a process 158 of the process analyzing unit 48. In the process 158, the information A simultaneously accessed as the related information to the attribute information table of the information B having been read in is registered. Then, as a process 160, the information B simultaneously accessed as the related information to the attribute information table of the information A is registered. Furthermore, when change of processing target (process transition) by the user from the information B to the information A is executed in a process 162 as a user process 134 to the information, processing monitoring unit 42 hooks the process transition from the information B to the information A in a process 164, delivers the data accompanied by the hooking to the process analyzing unit 48 and the process analyzing unit 48 registers the process transition from the information B to the information A into the attribute information table of the information A in a process 166. Concurrently, the process analyzing unit 48 registers the transition of the process from the information B to the information A into the attribute information table of the information B in a process 168. In this state, display of the related information of the information A is ordered in the related information display unit 60 by a process 170. At this time, assuming that the degree of relation is set as a sorting condition, the relation degree calculating unit 62 calculates the degree of relation of each piece of the related information of the information A in a process 172 and the related information display unit 60 displays in a list the pieces of related information of the information A sorted in order of the degree of the relation based on these degrees of relations in a process 174. Furthermore, when the access to the information A by the user has been ended in a process 176 in the user process 134 to the information, the processing monitoring unit 42 hooks the ending of the access to the information A in a process 178 and delivers the hooked data to the process analyzing unit 48. Receiving the hooked data, the process analyzing unit 48 orders the process management table creating unit 44 to update in a process 180 and deleting of items of the information A from the process management table 46 is executed in a process 182. The process analyzing unit 48 also orders the attribute information write-out unit 54 to write in by a process 184 and, receiving this order, the attribute information write-out unit 54 writes out the attribute information table of the attribute information A into the external storage apparatus in a process 186.

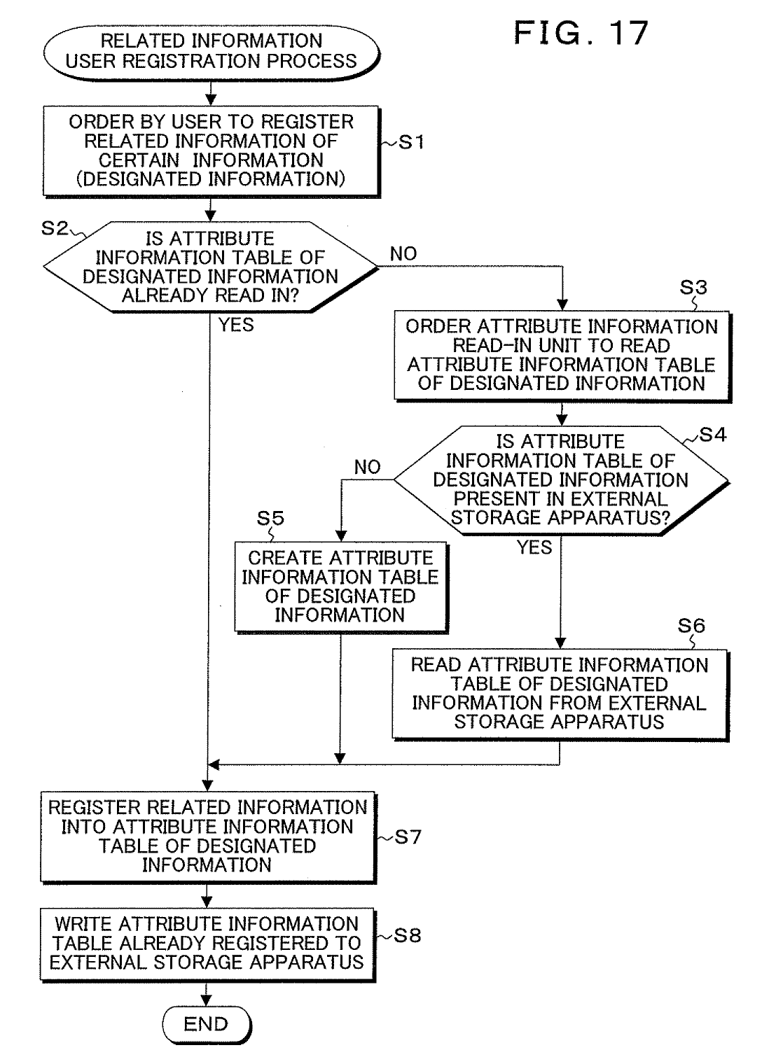

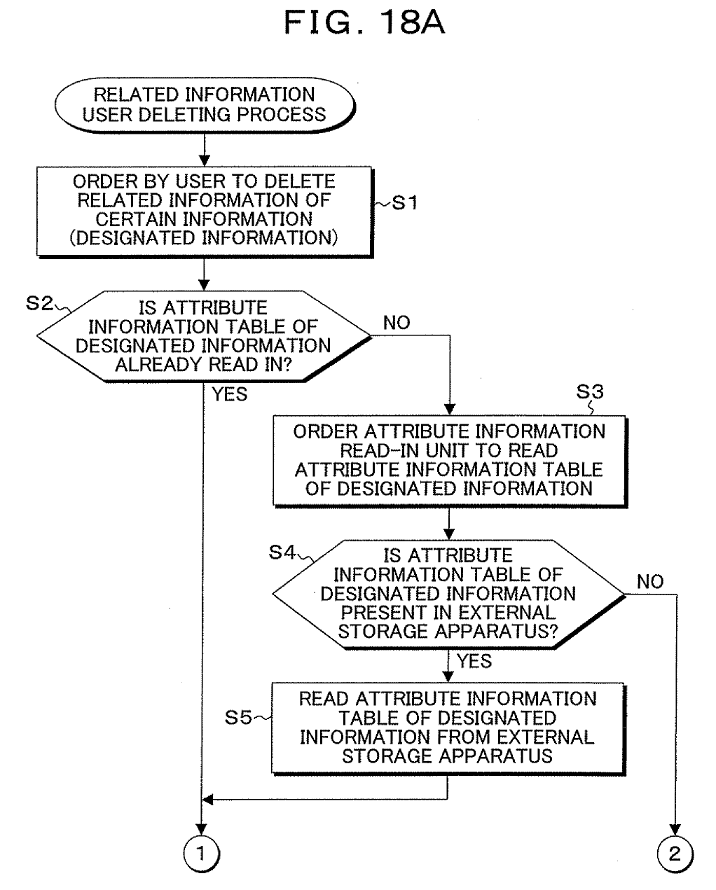

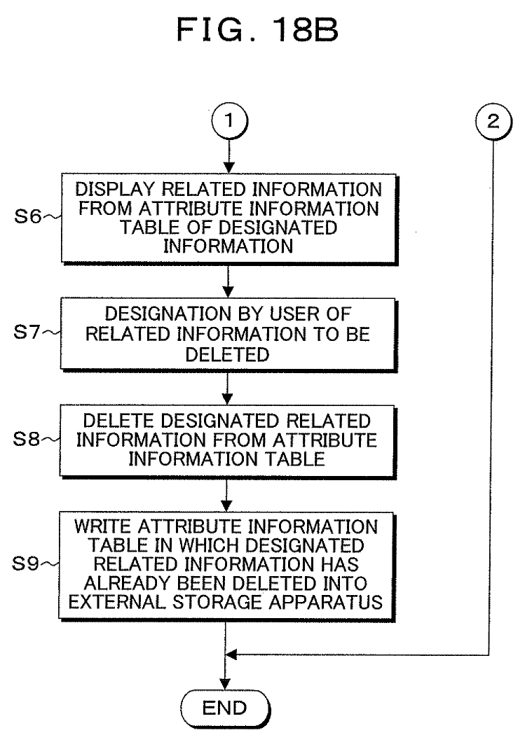

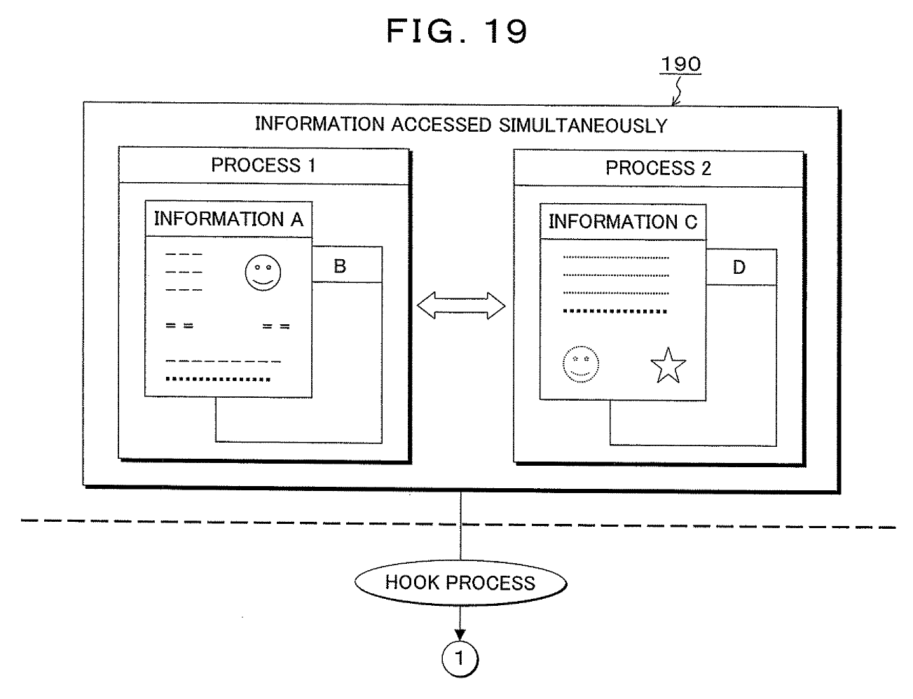

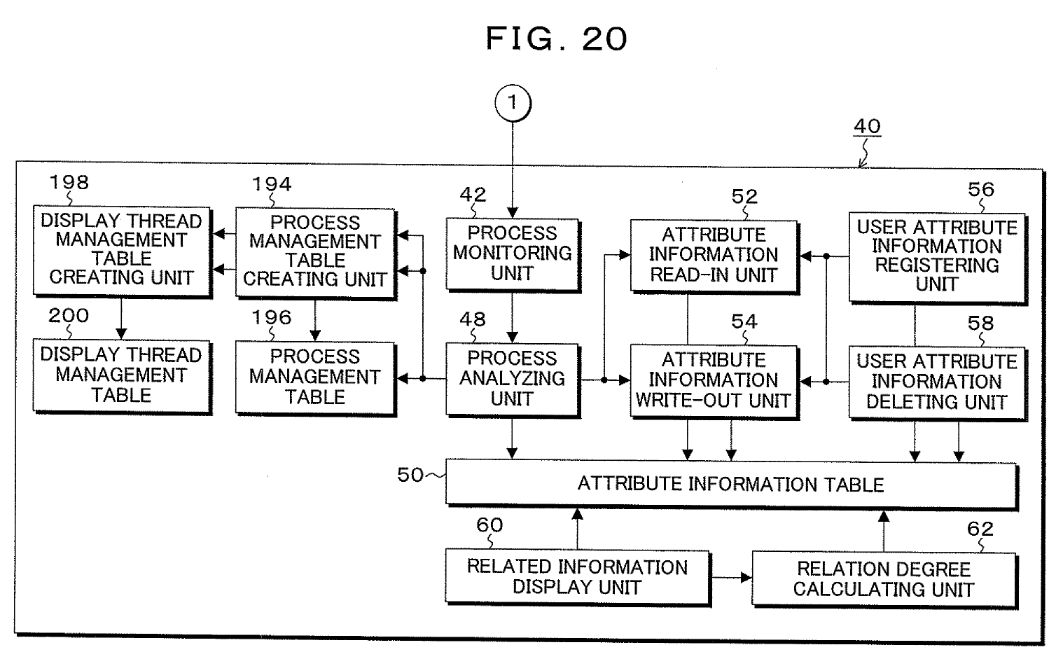

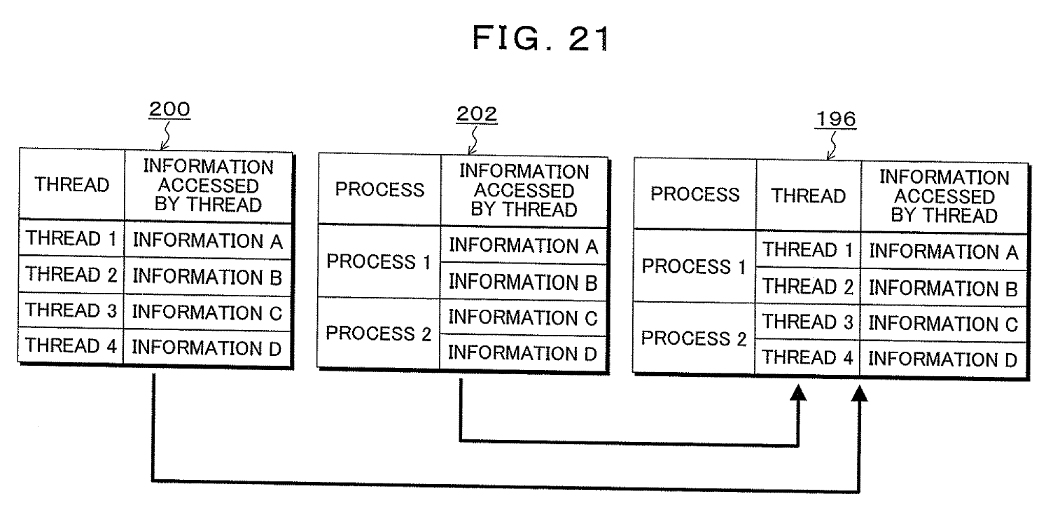

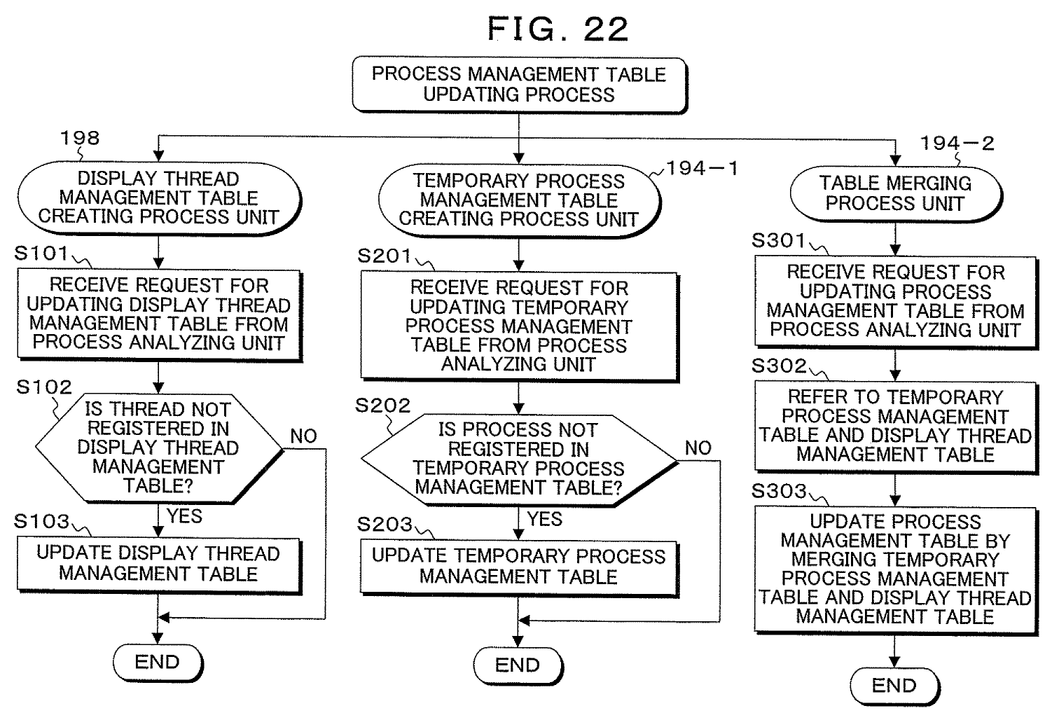

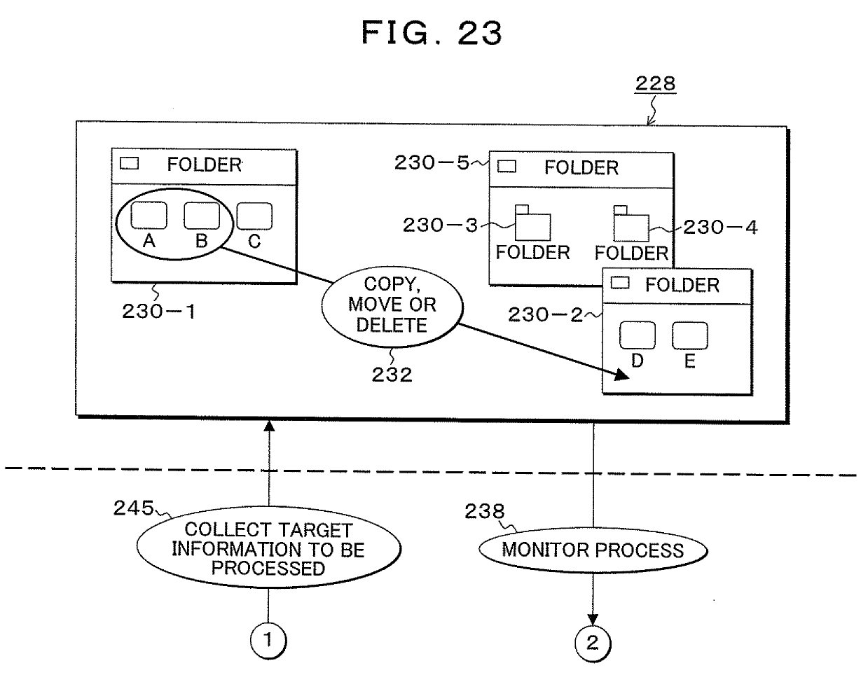

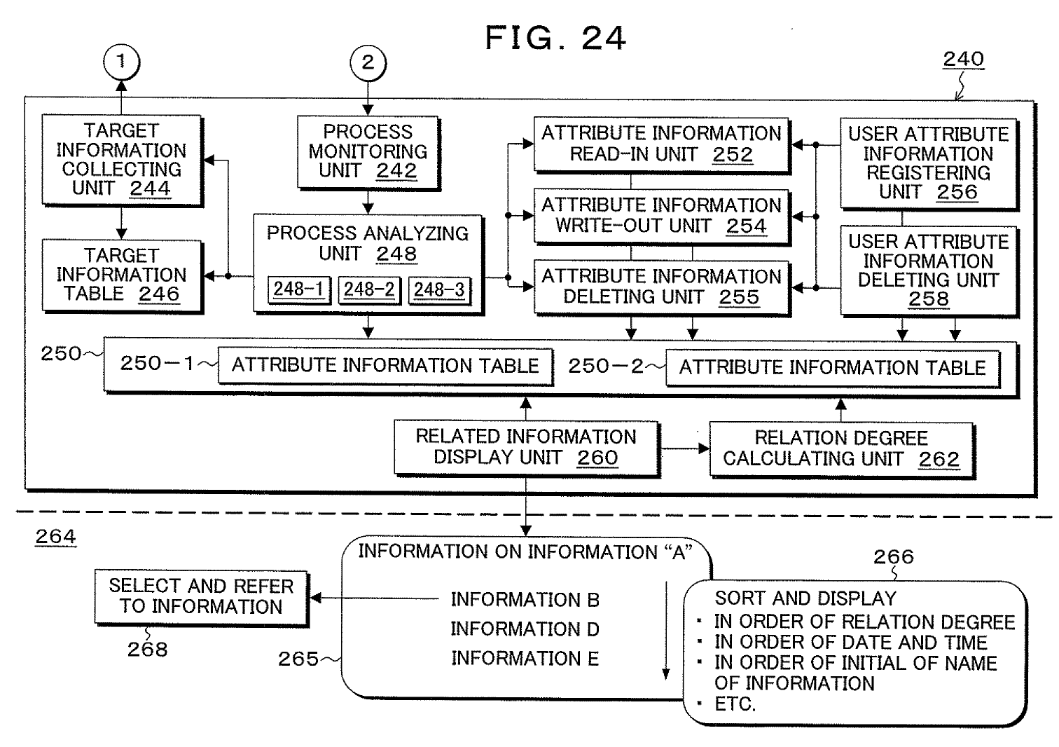

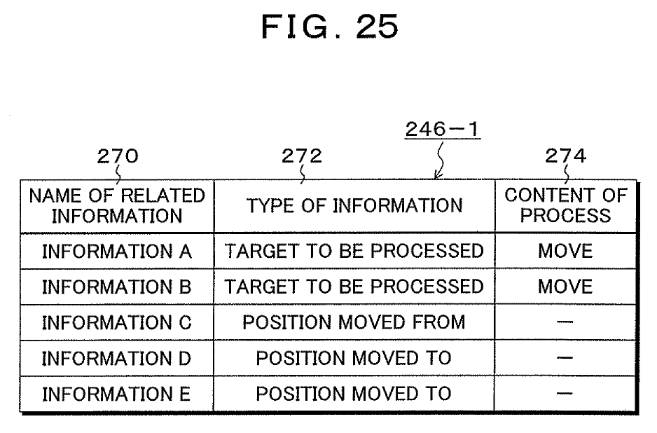

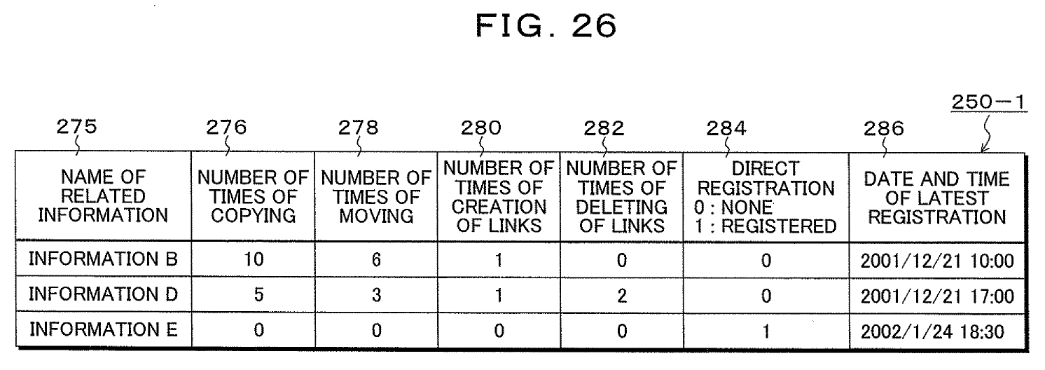

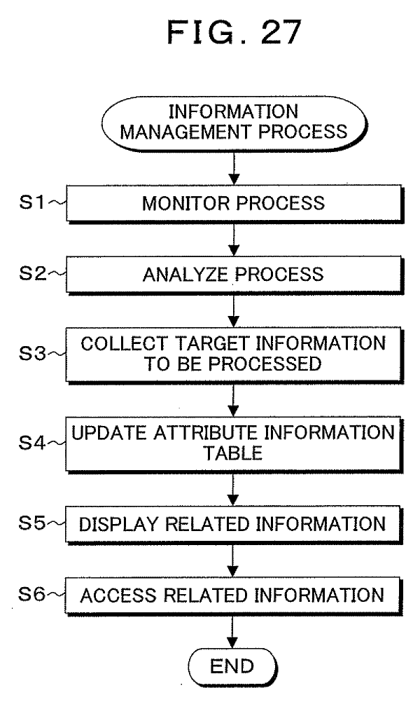

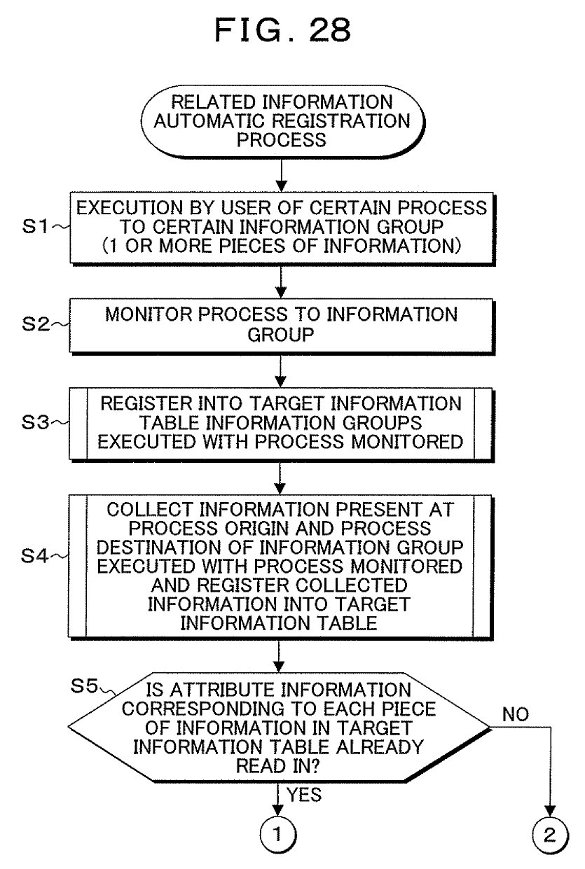

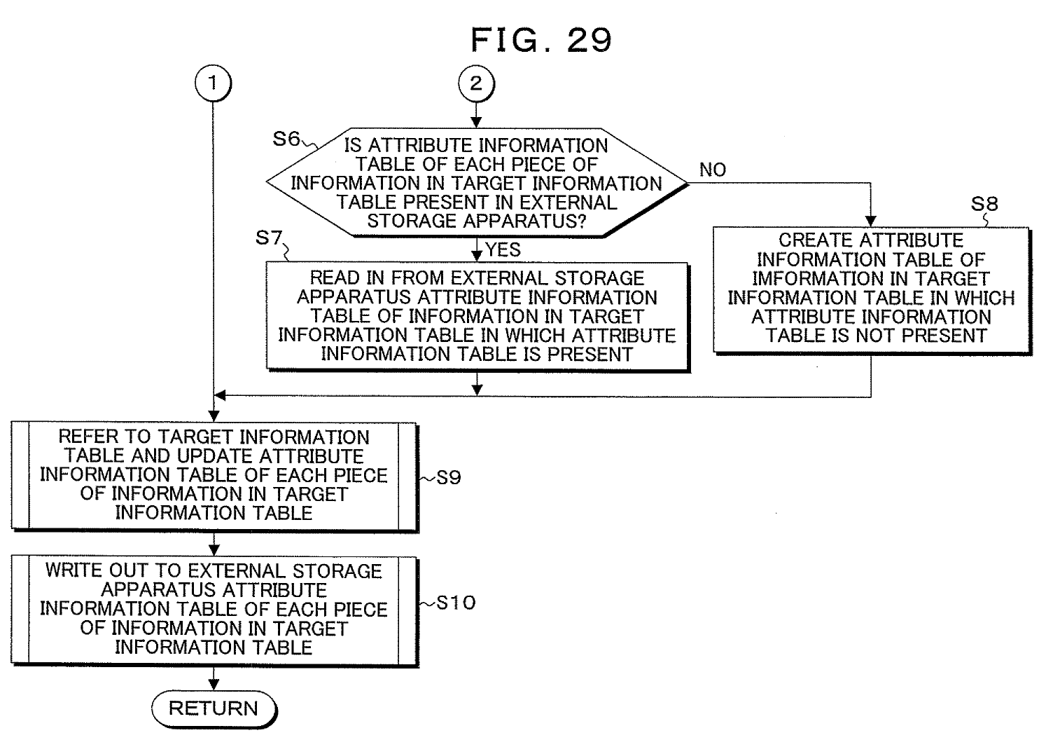

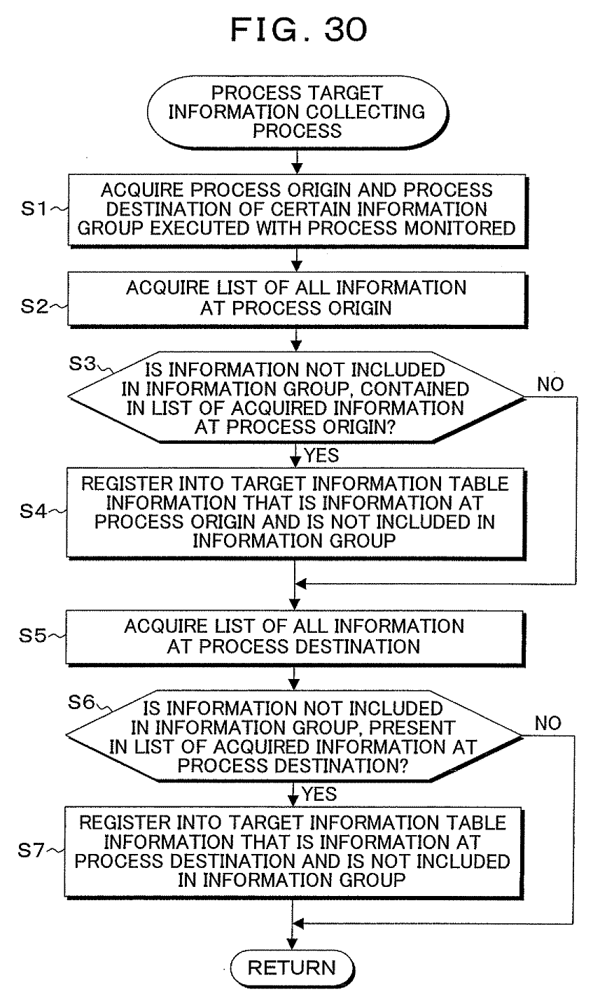

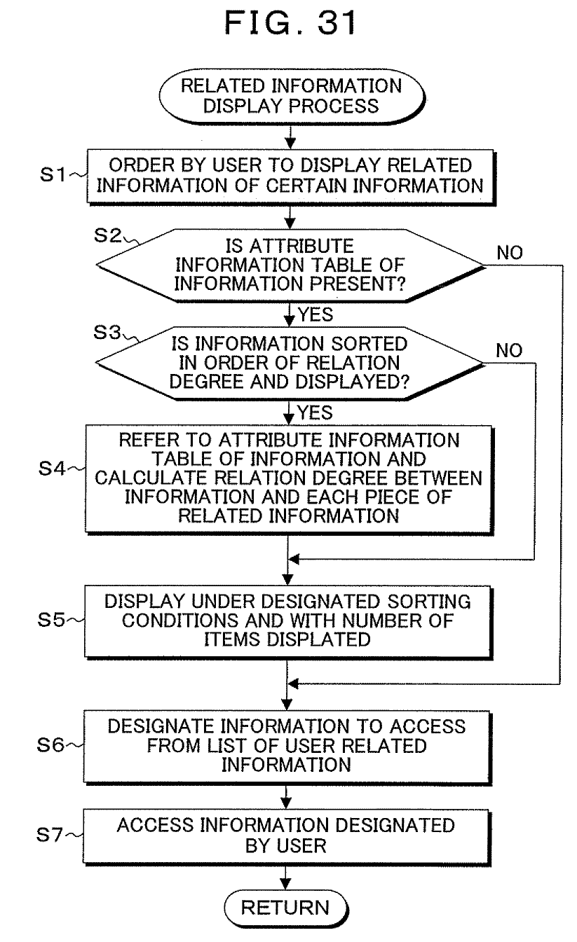

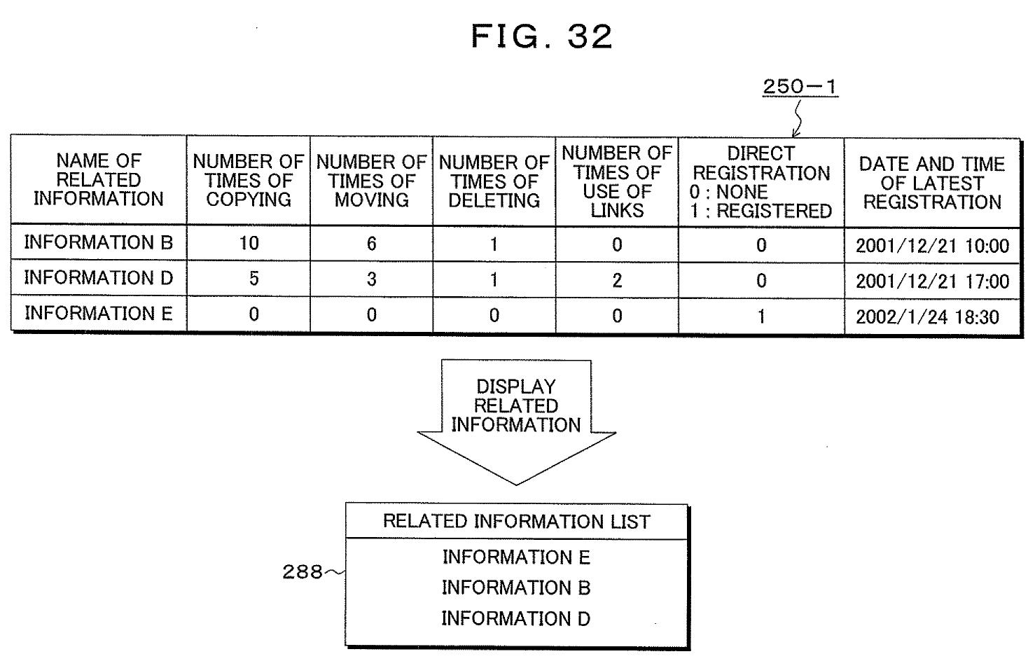

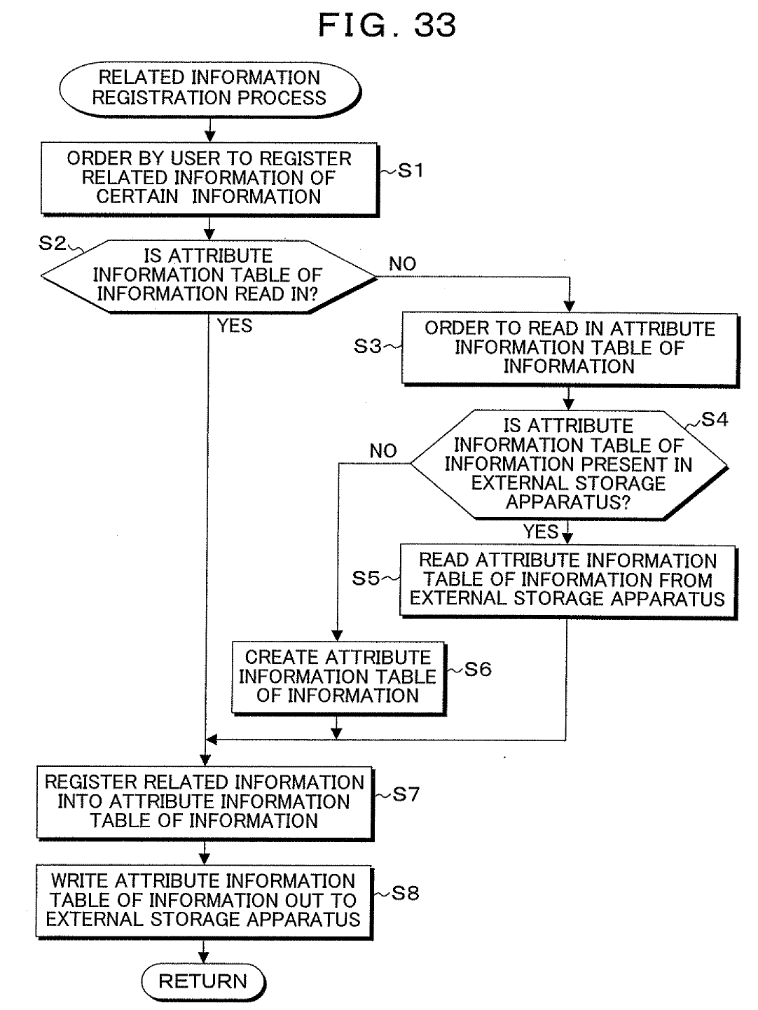

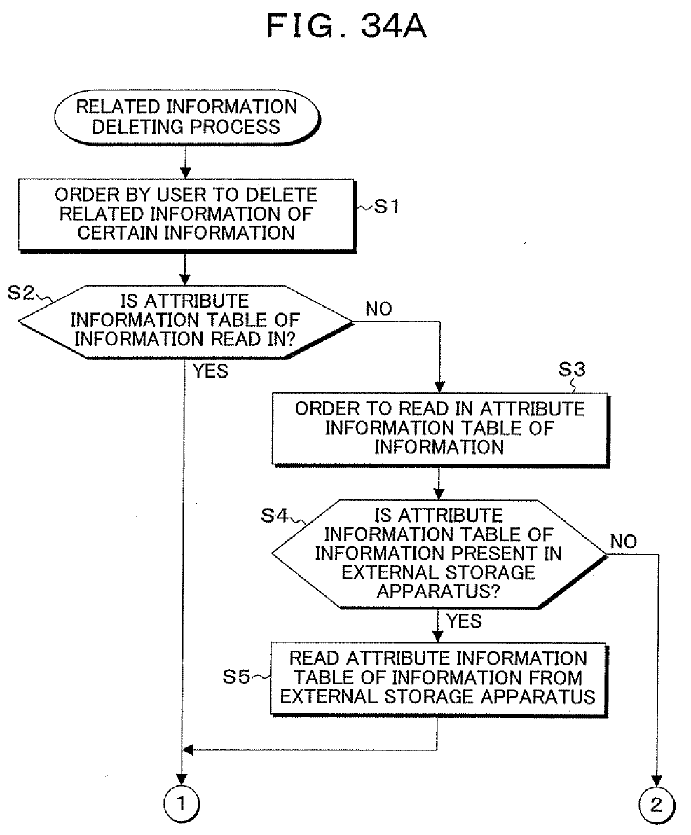

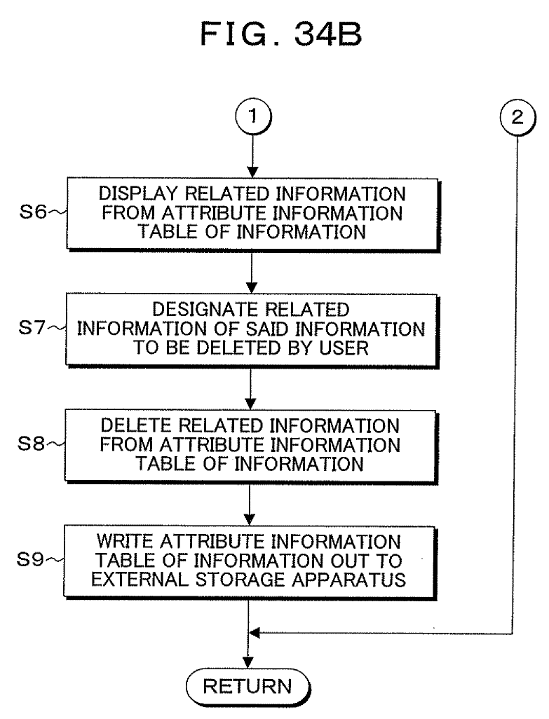

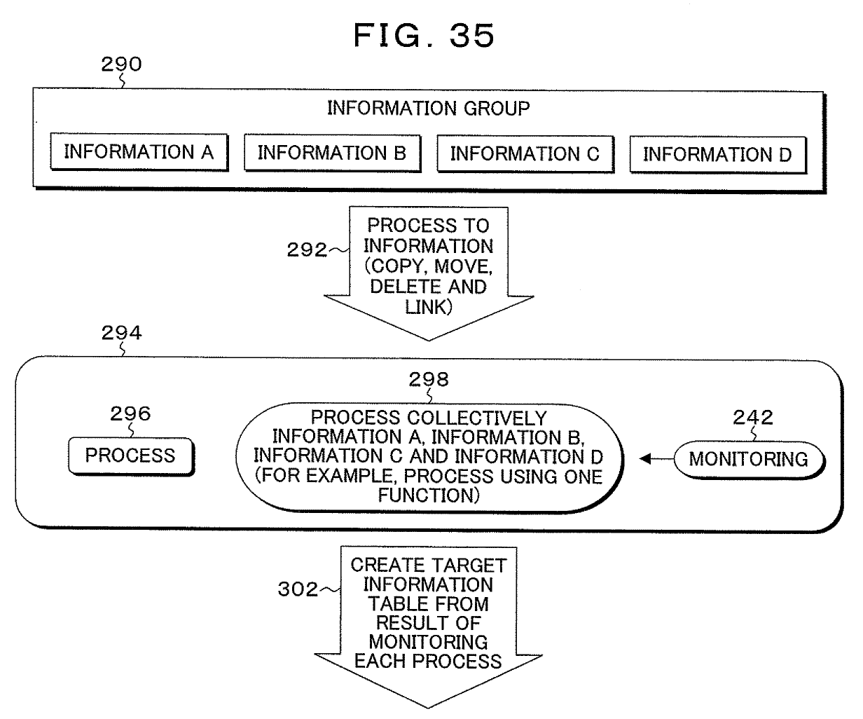

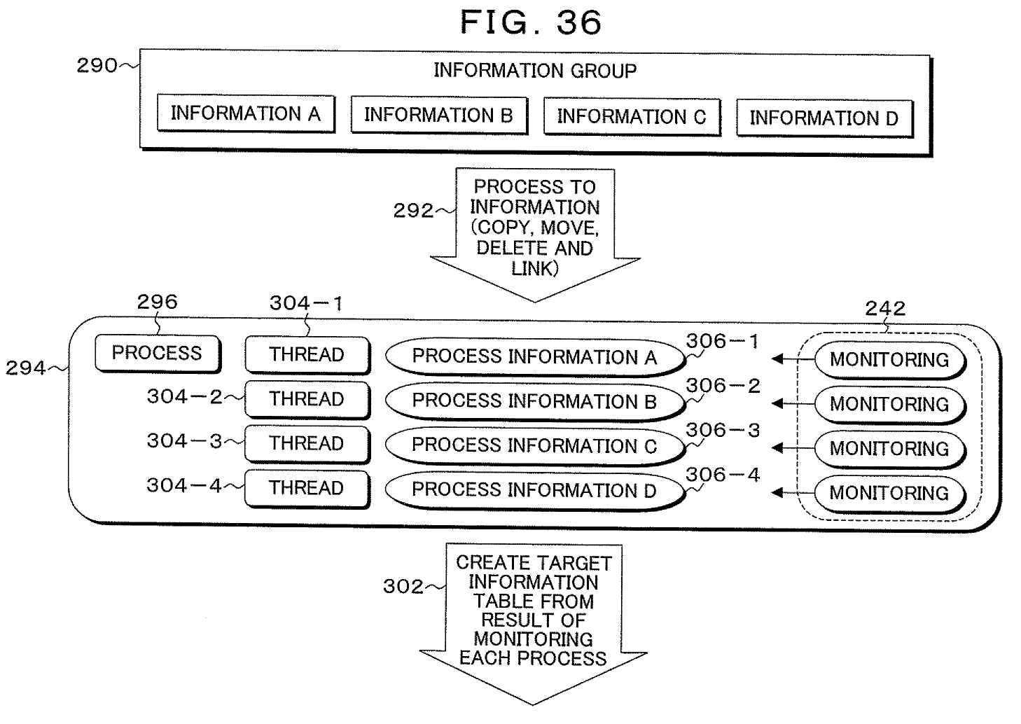

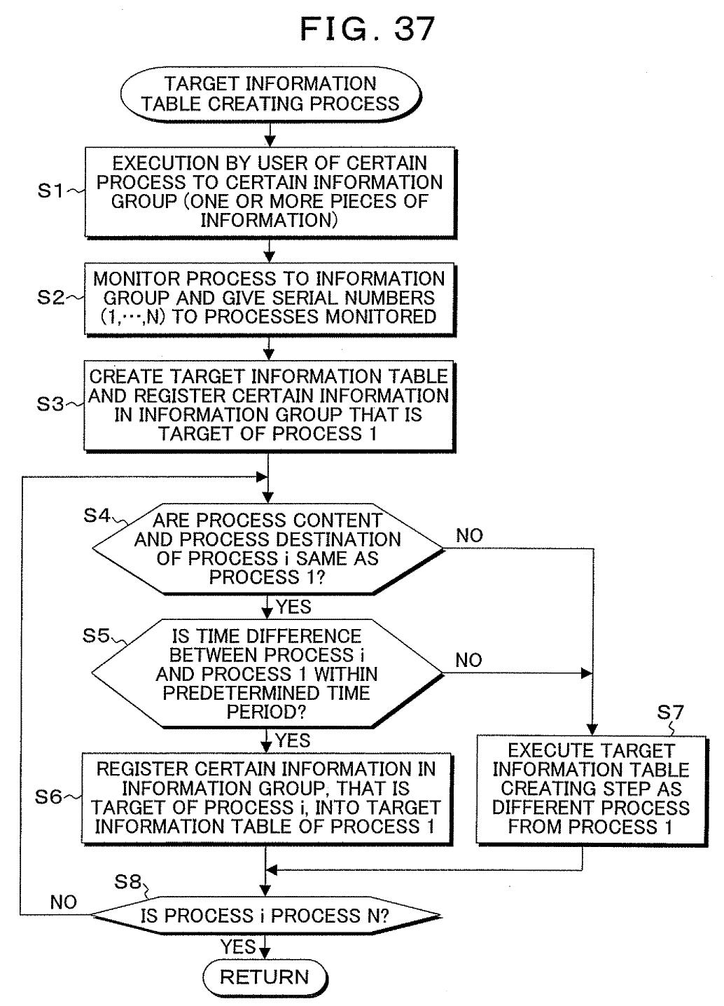

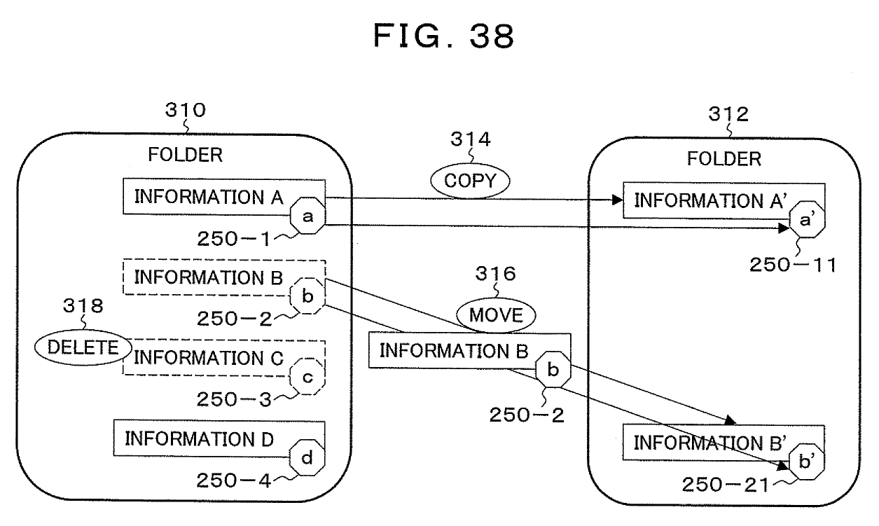

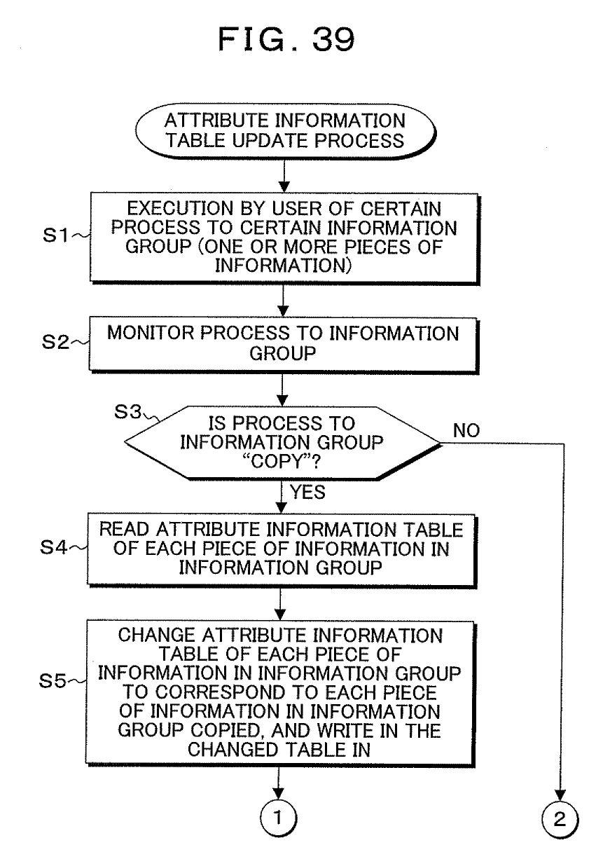

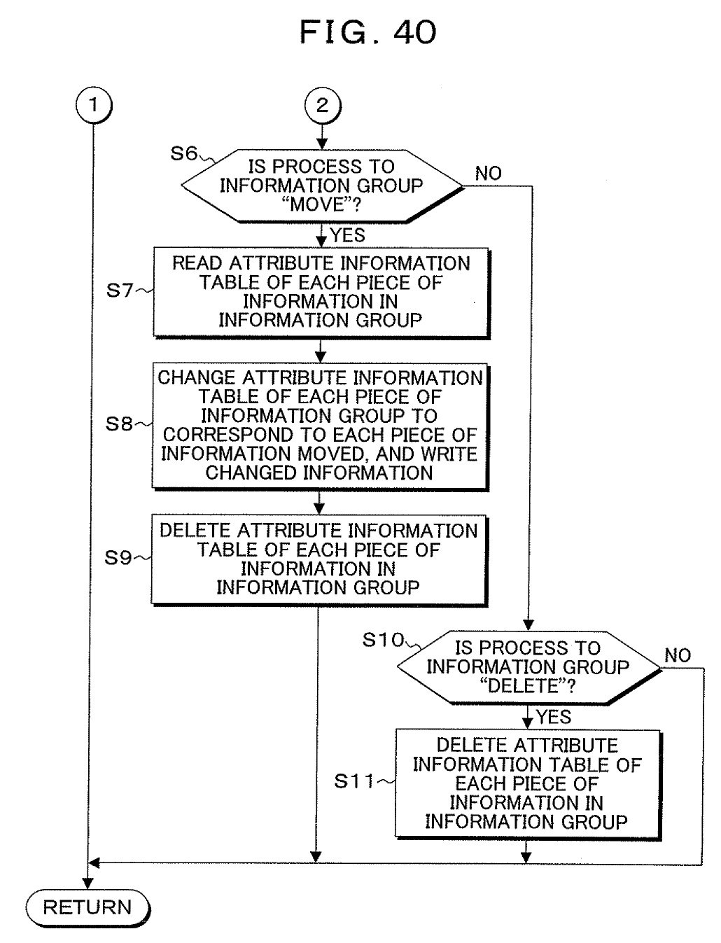

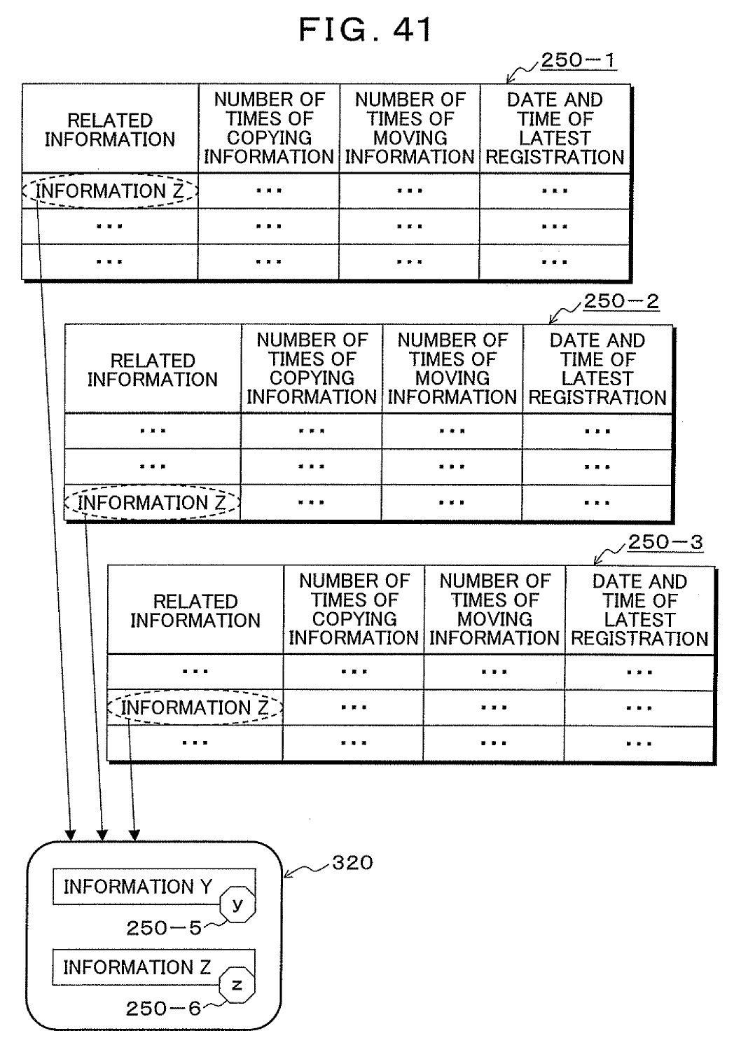

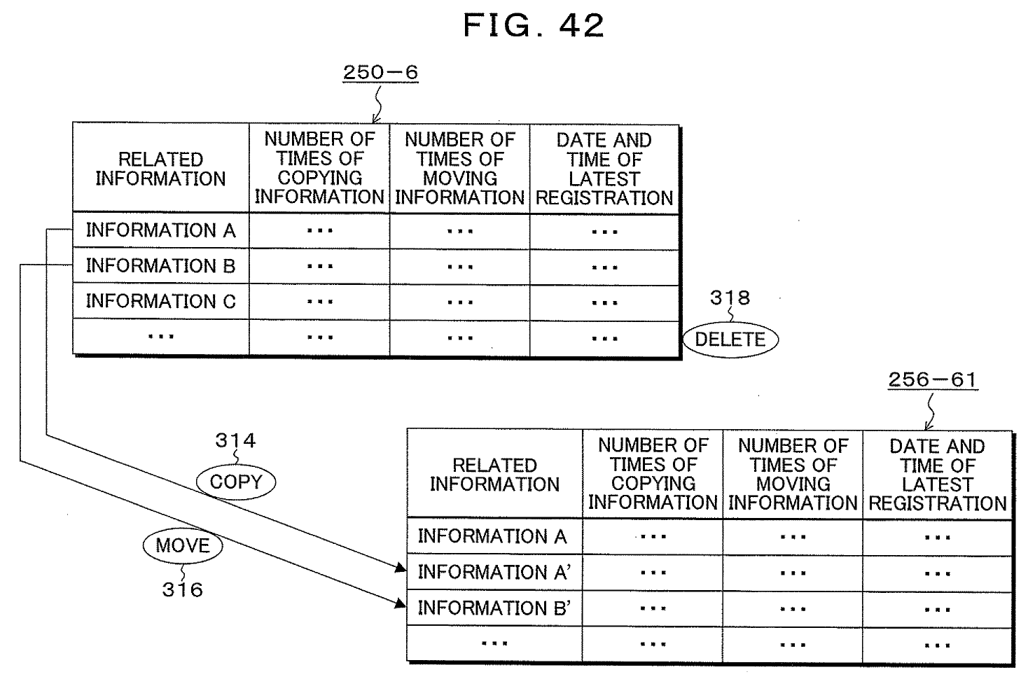

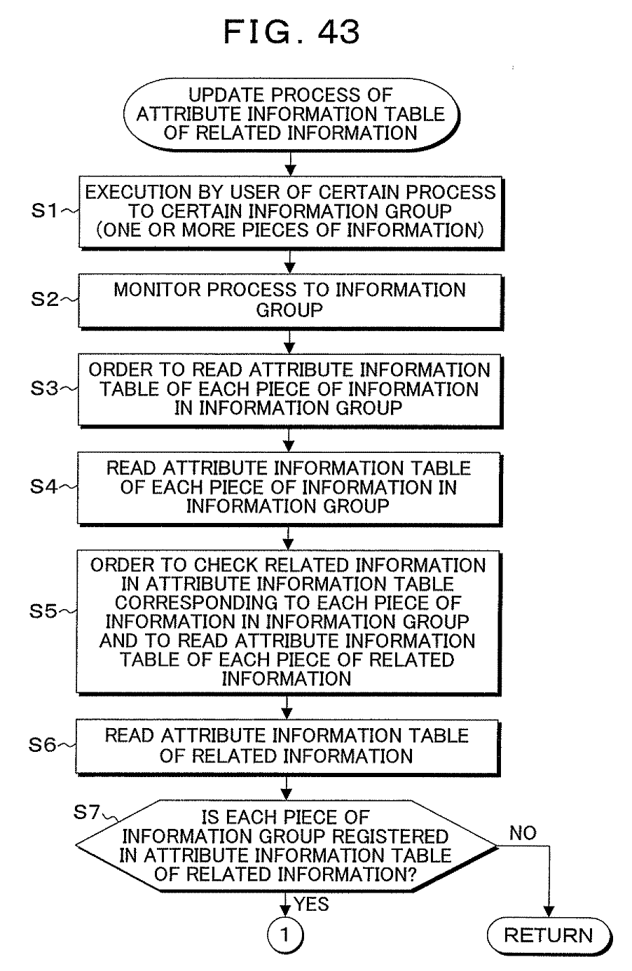

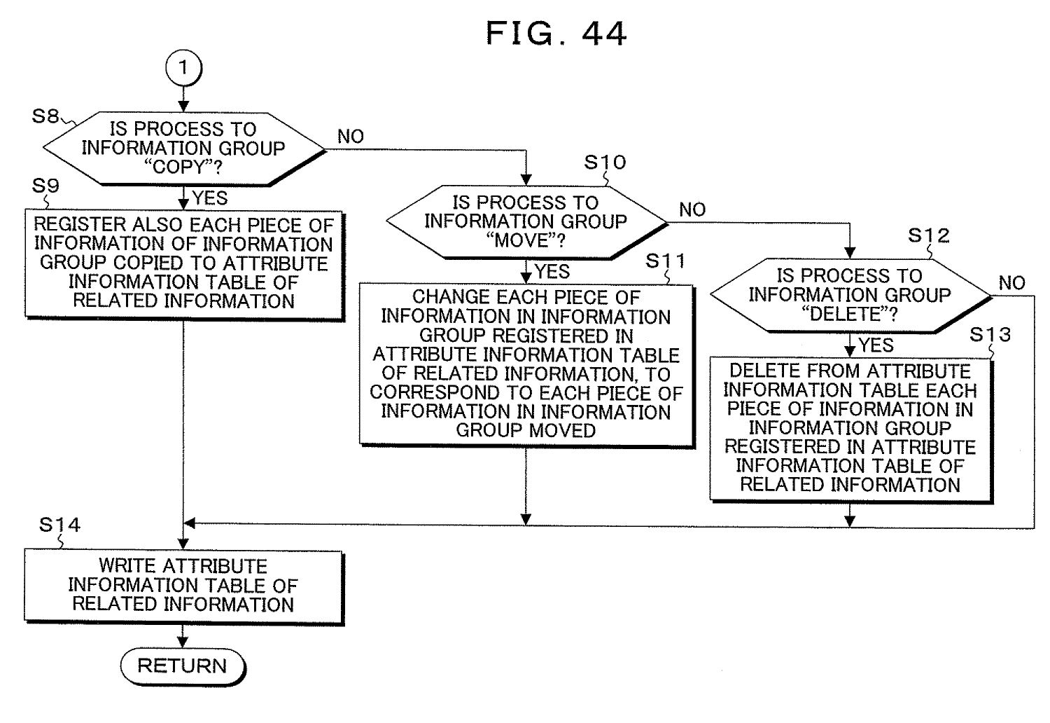

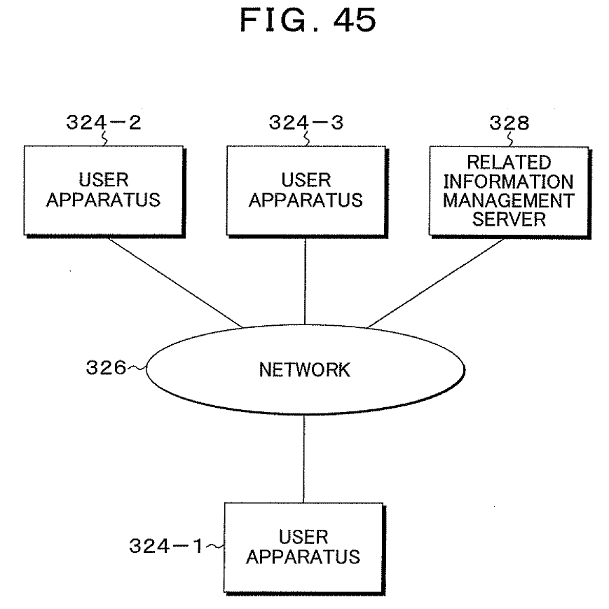

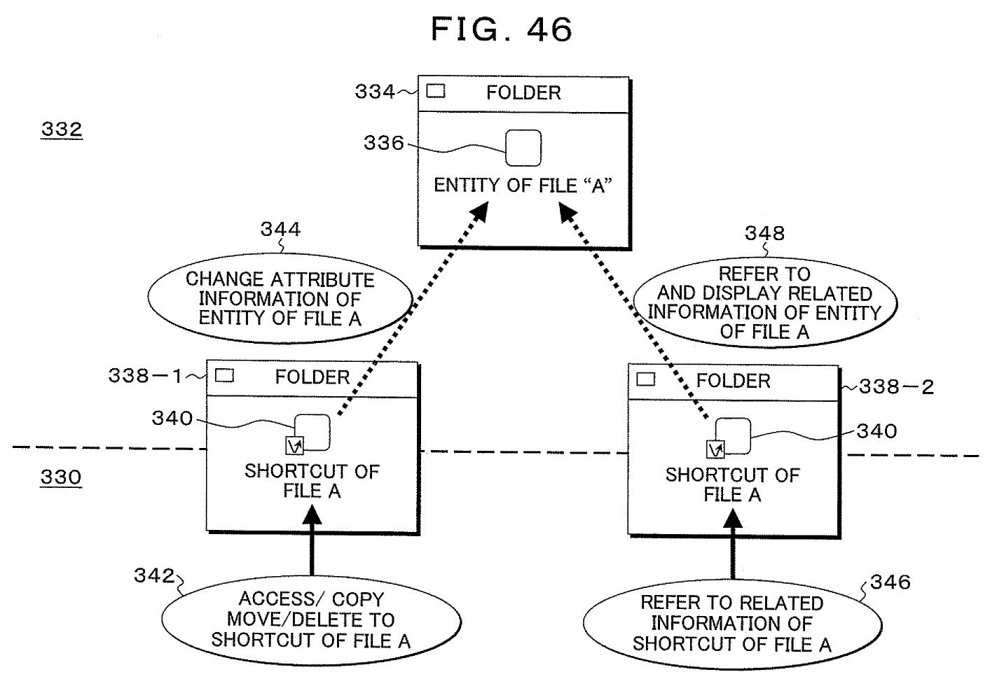

FIG. 17 is a flowchart of a related information user registration process by the user attribute information registering unit 56 provided to the related information management unit 40 of FIG. 3. When registration of related information of certain information is ordered by a user at a step S1, the user attribute information registering unit 56 determines whether or not the attribute information table of the information that is the target of the order has been read in at a step S2. If the attribute information table has not been read in, the procedure advances to a step S3 and reading in of the attribute information table of the information ordered (herein after, referred to as “ordered information”) is ordered to the attribute information read-in unit 52. Then, whether or not the attribute information table of the ordered information is present in the external storage apparatus at a step S4. If the ordered information is not present, an attribute information table of the ordered information is newly created at a step S5. If the ordered information is present, the attribute information table of the ordered information is read in from the external storage apparatus at a step S6. In the case where the attribute information table has been read in at the step S2, or has been read in from the external storage apparatus or newly created at the steps S3 to S5, the pieces of related information designated by the user are registered into the attribute information table of the designated information at a step S7. As to the related information registered in this case, for example, files are designated through a file reference dialogue of Windows XP (a registered trademark) and the files are registered as the related information. When the related information is registered, a flag “1” indicating that the related information has been directly registered is displayed as the attribute data of the related information like the information F in the item of a direct registration flag 90 in the attribute information table 50-1 of the information A of FIG. 5. Finally, the registered attribute information table is written into the external storage apparatus at a step S8.

FIG. 18 is a flowchart of a related information user deleting process by the user attribute information deleting unit 58 provided to the related information management unit 40 of FIG. 3. When deleting of the related information of certain information (herein after referred to as “ordered information”) is ordered by a user at a step S1, the user attribute information deleting unit 58 determines whether or not the attribute information table of the ordered information has been read in at a step S2 and, if the attribute information table is not present, orders the attribute information read-in unit 52 to read in the attribute information table of the ordered information at a step S3. Then, user attribute information deleting unit 58 checks whether or not the attribute information table of the ordered information is present in the external storage apparatus 26 at a step S4 and, if the attribute information table is not present, ends the process. If the attribute information table is present, the attribute information table of the ordered information is read in from the external storage apparatus at a step S5. In the case where the attribute information table of the ordered information has been read in at the step S2, or has been read in from the external storage apparatus at steps S3 to S5, thereafter, the pieces of related information are displayed in a list from the attribute information table of the ordered information at a step S6. Then, the pieces of related information to be deleted are designated by the user at a step 7 and, when confirming operation is executed by the user at a step S8, the designated pieces of related information are deleted. Finally, the attribute information table in which designated related information has already been deleted is written into the external storage apparatus 26 at a step S9.

FIGS. 19 and 20 together show a functional block diagram of a variation of the first embodiment of the related information management according to the present invention. The related information management of this embodiment is characterized in that the related information management is arranged to execute management of the related information by creation of process management tables containing a plurality of threads executed on a multi-thread OS. The plurality of threads can executed in a program (process) on the multi-thread OS. A thread is the unit of execution of a program on a multi-thread OS. That is, plural pieces of information can be accessed in one (1) process and each piece of information can be processed in a different thread respectively. In the embodiment, display threads are taken as examples. In FIG. 19, a piece of information by a process 1 and another piece of information by a process 2 are provided to a user interface 190 as pieces of information to be accessed simultaneously. The processes 1 and 2 access the information A, the information B, the information C and the information D by respectively two (2) thread. To the information management unit 40 of FIG. 20, similarly to the embodiment of FIG. 3, the processing monitoring unit 42, the process analyzing unit 48, an attribute information table storing unit 50, the attribute information read-in unit 52, the attribute information write-out unit 54, the user attribute information registering unit 56, the user attribute information deleting unit 58, the related information display unit 60 and the relation degree calculating unit 62 are provided. In addition to these, in the embodiment of FIG. 20, a process management table creating unit 194, a process management table 196, a display thread management table creating unit 198 and a display thread management table 200 are provided supporting the multi-thread OS.

FIG. 21 shows specific examples of a display thread management table 200, a temporary process management table 202 and a process management table 196 produced in the information management unit 40 of FIG. 20. The display thread management table creating unit 198 recognizes threads currently displayed and the information displayed by each thread through the process analyzing unit 48 and creates and updates the display thread management table 200 of FIG. 21 that clarifies the relations between threads and pieces of information. In the display thread management table 200 of FIG. 21, as the user interface 190 of FIG. 20, it is registered that the information A is currently displayed by thread 1 and the information C is currently displayed by thread 3. The process management table creating unit 194 recognizes on-going processes and pieces of information accessed by each process through the process analyzing unit 48 and, first, creates or updates the temporary process management table 202 of FIG. 21 that temporarily clarifies the correspondence relations between the processes and the pieces of information. In an example of the temporary process management table 202 of FIG. 21, it is registered in the temporary process management table 202, that the process 1 is processing the information A and the information B and the process 2 is processing the information C and the information D. In addition, the process management table creating unit 194 refers to the display thread management table 200 through the display thread management table creating unit 198 and creates the process management table 196 by merging the display thread management table 200 with the temporary management table 202. That is, the thread 1 and the thread 2 are registered in the process management table 196 due to the merging of the display thread management table 200 and the temporary process management table 202, and the information A is registered in the thread 1 and the information B is registered in the thread 2. Furthermore, the thread 3 and the thread 4 are registered in the process 2 and, moreover, the information C is registered in the thread 3 and the information D is registered in the thread 4. The correspondence relations between the three (3) of a process, a thread and information are managed by this process management table 196.

FIG. 22 is a flowchart of a process management table creating process in the embodiment of FIGS. 19 and 20. For a multi-thread OS such as Windows XP (a registered trademark), a thread is the unit of execution of a program and, in this case, a plurality of threads are executed in one (1) process, and the process and the information accessed by a user may not correspond one to one. Foe example, in the case where a plurality of files are accessed on Word (a registered trademark) on Windows XP (a registered trademark), though the process of Word (a registered trademark) is only one (1), the thread is created for each process for each file. More specifically, though a file is opened by a thread created by a process of Word (a registered trademark), another file opened by another thread is displayed on the screen. In the case where a process and information do not correspond one to one as described above, the process management table creating process of FIG. 22 is executed. In this flowchart, in addition to the display thread management table creating unit 198, the process management table creating unit 194 is divided into the function of a temporary process management table creating process unit 194-1 and the function of a table merging process unit 194-2, and is displayed in the flowchart. First, a display thread management table creating process unit 178, based on the data relating to the hooked process delivered from the analyzing process unit 48 at a step S101, confirms whether or not the hooked process is for a thread not registered in the display thread management table 200 at a step S102, If the thread is already registered, the creating process of the display thread management table 200 is ended.

If the thread is not yet registered, the procedure advances to a step S103 and the combination of the thread and the information is registered in the display thread management table to update this table. For example, considering the case where access to a plurality of files is started on Word (a registered trademark) on Windows XP (a registered trademark), when the thread displays each file in the window, the processing monitoring unit 42 hooks the process and delivers the hooked process to the process analyzing unit 48. The process analyzing unit 48 delivers identifying information representing uniquely the thread of each window and the names of files (information names) displayed in the window to the display thread management table creating unit 178. The names of the files displayed in the window are obtained from the character lines of the title bar, etc. From the thread identifying information and the names of window display from the analyzing process unit 48 as above, updating of the display thread management table 200 can be executed by registering the combination of the thread and the information. The temporary process management table creating process unit 194-1 confirms whether or not the hooked process corresponds to a process not registered in the temporary process management table 202 based on the data relating to the hooked process delivered from the process analyzing unit 48 at the step S201, more specifically, the identification information uniquely determining the process and data containing the name of the information currently accessed by this process, at the step S202. If the hooked process is a registered process, the updating process for the temporary process management table 202 is ended. If the hooked process is not a registered process, the combination of the process and the information is registered into the temporary process management table at a step S203. For example, in the case where an access has been started to a plurality of files on Word (a registered trademark) on Windows XP (a registered trademark), the names of the plurality of files to which the access has been started for one (1) process on Word (a registered trademark) are registered into the temporary process management table 202 as the name of the information. After the creation of the display thread management table 200 and the temporary process management table 202 by the display thread management table creating unit 198 and the temporary process management table creating unit 194-1 has been finished as described above, based on a update request of the process management table 196 from the process analyzing unit 48 at a step S301, the table merging process unit 194-2 refers to the temporary process management table 202 and the display thread management table 200 at a step S302 and updates the process management table 196 by merging the above two (2) tables at a step S303. As to the related information automatic registration process and the related information display process after the creation of the process management table 196 that registers the correspondence relation of processes, threads and information targeting a multi-thread OS as above and, in addition, the access for referring to the related information, similarly to the case where the process and the information corresponds one to one as in the embodiment of FIGS. 2 and 3, the attribute information table of the information of the process origin and the attribute information table of the information of the processing destination are respectively updated by hooking the access to the information executed for each respective process. In addition, display of the related information based on the attribute information table of the information corresponding to the thread currently executed by user, or display of the related information based on the attribute information table about the information designated directly by the user and, in addition, an access of the related information by selecting the related information displayed are also executed.

### (Related Information Management of User Processing of Information Group)

FIGS. 23 and 24 together show a block diagram of the functional composition of a second embodiment of the related information management according to the present invention targeting a user process to an information group. In FIGS. 23 and 24, a related information management unit 240 provided by the present invention is provided with a user interface 228 and, on the user interface 228, a user executes processes such as moving, copying, deleting, etc. to an information group storing plural pieces of information for creation or edit of a document or an image. In this example, folders 230-1 to 230-5 are shown as the information group. For example, the folder 230-1 stores in the folder thereof the information A, the information B and the information C and, as a user process 232, for example, a process of moving the information A and the information B in the folder 230-1 into another folder 230-2 is executed. The information D and the information E are already stored in the destination of the moving, the folder 230-2 and the information A and the information B moved from the folder 230-1 are added into this folder. The folders 230-3 and 230-4 are stored in the folder 230-5 and processes such as copying, moving, deleting, etc. can be executed also handling the folders 230-3 and 230-4 as one (1) piece of information. The related information management unit 240 of the present invention is provided with a monitor process unit 242, a processing target information collecting unit 244, a processing target information table 246, an analysis process unit 248, an attribute information table storing unit 250, an attribute information read-in unit 252, an attribute information write-out unit 254, an attribute information deleting unit 255, a user attribute information registering unit 256, a user attribute information deleting unit 258, a related information display unit 260 and a relation degree calculating unit 262. When a user executes a process such as moving, copying, deleting, etc. on the user interface 228, the monitor process unit 242 detects this process and delivers the process to the analysis process unit 248. Here, the information group that is the target of the process of a user is the following information.

### (1) Files;

### (2) Folders;

(3) WWW pages; and
(4) Links of a file;

The processes by a user monitored by the monitor process unit 242 are the following processes.

(1) Copying of information;
(2) Moving of information;
(3) Deleting of information;
(4) Creation of a link of information;
(5) Moving of a link of information;
(6) Deleting of a link of information; and
(7) Drag and drop.

The analysis process unit 248 is provided with the function of a first processing analyzing unit 248-1 that creates the processing target information table 246 registering each piece of information in the information group that is the target of the collective processing of a user from the result of the monitoring by the processing monitoring unit 242, and the processing target information table 246 created by the above function is created for each process by user. Next, the process analysis unit 248 is provided with a function as a second process analysis unit 248-2 that refers to the processing target information table 246 created, analyzes what type of process has been executed to each piece of information registered in the processing target information table and extracts the relation between the pieces of information. Furthermore, the process analysis unit 248 is provided with a function as a third process analysis unit 248-3 that creates an attribute information table registering the relation between the pieces of information extracted, for example, the attribute information table 250-1 and stores the created table in the attribute information table storing unit 250. This attribute information table is created for each piece of information registered in the processing target information table 246. Here, the processing target information table 246 created by the analysis process unit 248 is a table like, for example, a processing target information table 246-1 of FIG. 25. This processing target information table 246-1 is created based on the result of monitoring obtained from the monitor process unit 242 about the process to move collectively the information A and the information B in the folder 230-1 into the folder 230-2 on the user interface 228 of FIG. 23. That is, the processing target information table 246-1 comprises the name of related information 270, the information type 272 and the content of the process 274, and “information A” and “information B” are registered in the name of related information 270, the “content of the process” is registered for each of two pieces of information as the information type 272 and, in addition, “move” is registered as the content of the process 274 based on the result of monitoring of the collective moving process by a user on the user interface 228. Moreover, by the processing target information collecting unit 244 of FIG. 24, a process for checking and registering the information that is not the target of the process (non-target information) contained in the information group of the process origin and the information group of the processing destination that are the target of the process by the user is executed to the processing target information table 246-1 created as above based on the result of the monitoring of the collective user process.

In the collective move process of the information A and the information B from the folder 230-1 to the folder 230-2 on the user interface 228 of FIG. 28, first, the information C that is not the target of the process is detected by checking the folder 230-1 of the process origin, registers the detected information C into the name of the related information 270 as “information C” and registers “process origin” as the information origin 272. The content of the process 274 is not the target of the process and is made blank. Next, the folder 230-2 of FIG. 23 that is the destination of the move is checked and the “information D” and the “information E” are collected. Then, the “information D” and the “information E” collected from the destination of the move are registered into the name of the related information 270 and “move destination” is registered respectively for the information type 272. In this case, the content of the process 274 is also made blank because the pieces of information are not the target of the process. Here, a collective move process by user targeting files has been taken as an example, information at the process origin and the processing destination checked and collected by the processing target information collecting unit 244 is information as follows including a file.

(1) A file (including a file stored in an archive file)
(2) A folder;
(3) Information in a database; and
(4) Information that an application is processing.

FIG. 26 shows a specific example of an attribute information table registering the relations between pieces of information extracted by analyzing what type of process has been executed to the pieces of information registered in the processing target information table 246 by the analysis process unit 248 of FIG. 24, and the related information of certain information and the attribute information such as the content and the number of times of the process executed to the certain information and the related information are recorded in an attribute information table. The attribute information table 250-1 of FIG. 26 is an example of the attribute information table created for the information A registered in the processing target information table 246-1 of FIG. 25. The attribute information table 250-1 is provided with the name of Related information 275, the number of times of copying 276, the number of times of moving 278, the number of times of creation of links 280, the number of times of deleting of links 282, direct registration 284, and the date and time of latest registration 286. In this case, because this table is the attribute information table 250-1 of the information A, the information B, the information D and the information E are recorded as the related information in the name of the related information 275. Here, taking an example of the relation between the information A and the information B that is the related information for the attribute information table 250-1, it is recorded that ten (10) times of copying, six (6) times of moving and one (1) time of link creation have been executed as a collective processing for the information A and the information B and, moreover, it is recorded that the latest date and time at which the attribute value information relating to the information B was registered is 10:00 a.m. on Dec. 21, 2001.

Furthermore, the process analysis unit 248 checks the related information registered in the attribute information tables of the pieces of information in the information group that is the target of the process, and checks whether or not the pieces of information in the information group that is the target of the collective user process are registered in the attribute information tables of the checked related information. As the result of this, if the pieces of information in the information group that is the target of the collective user process are registered in the attribute information table of the related information, the process analysis unit 248 changes the registered contents of the pieces of information in the information group that is the target of the collective user process registered in the attribute information table of the related information checked, according to the contents of the processes such as copying, moving, deleting, etc. Furthermore, the attribute information read-in unit 252 provided to the related information management unit 240 of FIG. 24 reads in the attribute information tables from the external storage apparatus according to the order of the process analysis unit 248. Then, the attribute information write-out unit 254 writes out the attribute information tables into the external storage apparatus according to the order of the process analysis unit 248. In addition, the attribute information deleting unit 255 deletes the attribute information table from the external storage apparatus according to the order of the process analysis unit 248. The related information display unit 260 sorts and displays the degree of relation, the date and time of registration of the attribute information, the name of information, etc. obtained by the related degree calculating unit 262. For example, in the where a user has designated the information A, the related information display unit 60 displays, for example, the information B, the information D and the information E as the related information list 265 as on the user interface 62. The display of the plural pieces of related information in the related information list 265 is displayed in the order sorted according to a related information display rule 266. The details of the degree of relation, the date and time, the name of the related information defined by this related information display rule 266 are basically same as the related information display rule 66 in the first embodiment of FIGS. 2 and 3. Furthermore, the user attribute information registering unit 256 provided to the related information management unit 240 of FIG. 24 directly registers the related information and the attribute information of the related information into the attribute information table of the selected information according to the order of the user. The user attribute information deleting unit 258 directly deletes the related information and the attribute information from the attribute information table of the selected information according to the order of the user.

FIG. 27 is a flowchart of the basic process procedure of the related information management processing targeting the collective user process according to the second embodiment of FIG. 24. In FIG. 27, the process by user to an information group including plural pieces of information, for example, a folder is monitored at Step S1. When the result of monitoring to the collective user process is obtained at a step S1, the content of the collective user process is analyzed and is registered into the processing target information table at the next step S2. Next, pieces of information at the process origin and the processing destination of the collective user process are collected and registered into the processing target information table at a step S3. Then, attribute information tables are updated for each piece of information based on the content of the processing target information table obtained by the process analysis and the collection of the processing target information at Step S2 and S3, at a step S4. Next, as to certain information, the related information registered in the attribute information table of the information is displayed at a step S5 and, when a user selects the displayed related information, the selected related information is accessed at a step S6.

FIGS. 28 and 29 together show a flowchart of the attribute information automatic registration process in the second embodiment of FIGS. 23 and 24 and this flowchart represents the details of Step S1 to S4 of FIG. 27. In FIGS. 28 and 29, when it is determines that a process is executed by a user to a certain information group at a step S1, the procedure advances to a step S2 and the processing monitoring unit 242 monitors the process of the user and notifies of the result of the monitoring to the process analyzing unit 248. Here, as the process by the user in the step S1, copying, moving, deleting, etc. of information can be listed as described above. As the information group to which the user has executed the process, files, folders, www pages, file links, etc. can be listed as described above. For example, in the case where a user executes a process such as copying, moving, etc. to a set of files or a set of folders or a set of files and folders, the processing monitoring unit 242 monitors these processes and notifies of the result of the monitoring to the process analysis unit 248 at a step S2. Then, the process analyzing unit 248 registers the information group to which the process notified from the processing monitoring unit 424 has been executed into the processing target information table 246 at a step S3. For example, as shown in the user interface 228 of 19, in the case where the information A and the information B in the folder 230-1 are collectively moved to the folder 232, the process analyzing unit 248 executes registration of “information A” and “information B” for the name of the related information 270, registration of “processing target” for the information type 272 and registration of “move” for the content of the process of the processing target information table 246 of FIG. 21. Next, the process analyzing unit 248 evokes the processing target collecting unit 244 at a step S4. The processing target collecting unit 244 collects pieces of information at the process origin and the processing destination obtained as the result of the monitoring by the processing monitoring unit 242 and registers the collected pieces of information into the processing target information table 246. The details of this processing target information process at the step S4 is as described in the flowchart of FIG. 30.

In FIG. 30, the processing target information collecting process, first, obtains the process origin and the processing destination of the information group to which the monitored process has been executed at a step S1 and obtains a list of all the pieces of information at the process origin at a step S2. For example, in the case of the folder 230-1 that is the process origin of FIG. 23, the information A, the information B and the information C are obtained. Next, whether or not any piece of information not included in the information group that is the target of the process is present in the obtained list of information of the process origin is determined at a step S3. In this case, because the information C is the information not included in the information group that is the target of the process, the procedure advances to a step S4 and the information C not included in the information group that is the target of the process among the pieces of information of the process origin is registered into the processing target information table 246-1 of FIG. 25. That is, “information C” is registered in the name of related information 270, the “move origin” is registered for the information type 272. Next, the list of all the pieces of information at the process origin is obtained at a step S5. For example, the information D and the information E in the folder 230-2 that is the move destination of FIG. 23 are obtained. Then, any piece of information not contained in the information group that is the target of the process is present in the obtained list of the pieces of information of the processing destination at a step S6. In this case, because the obtained information D and the information E are not included in a group consisting of the information A and the information B that are the targets of the move process, the procedure advances to Step S7 and the information D and the information E not included in the information group that is the target of the process among the pieces of information of the processing destination are registered as, for example, shown in the case of the processing target information table 246-1 of FIG. 25.

Referring again to FIG. 28, when the collection of the pieces of information at the process origin and the processing destination and registration of the collected pieces of information into the processing target information table at the step S4 have been finished, the procedure advances to a step S5 and the process analyzing unit 248 checks whether or not the attribute information table corresponding to the pieces of information in the processing target information table has been read in. If the table has not been read in, the procedure advances to a step S6 and whether or not the attribute information table of the pieces of information in the processing target information table is present in the external storage apparatus is checked. If the table is present, the attribute information read-in unit 252 is caused to read in from the external storage apparatus at a step S7. If the table is not present at the step S6, an attribute information table of the pieces of information in the processing target information table that is not present is newly created at a step S8. Then, the processing target information table 246 is referred to and the attribute information tables of the pieces of information in the processing target information table 246 are updated at a step S9. For example, in the case of the processing target information table 246-1 of FIG. 23, the attribute information tables of the information A, the information B, the information C, the information D and the information E are updated. The content of this registration of the processing target information table 246-1 describes the state where the information A and the information B are collectively moved, the information C is present at the move origin and the information D and the information E are present at the move destination. In this case, as shown in FIG. 26, the result of the update is that, in addition to the information B that has been moved together, the information D and the information E of the move destination with which the relation has been made more close by the move are registered in the attribute information table 250-1 of the information A while the information C of the move origin with which the relation has been made weaker by the move has been deleted.

Here, clarifying the attribute information for the related information to be registered into the attribute information table, the information as follows is registered.

(1) The number of times copied together;
(2) The number of times moved together;
(3) The number of times deleted together;
(4) The number of times of creating links;
(5) The number of times moved on a link together;
(6) The number of times of deleting a link together;
(7) The number of times present at the processing destination;
(8) The number of times present at the process origin; and
(9) The latest date and time of the registration.

When updating of the attribute information tables has finished at a step S9, the process analyzing unit 24B orders and causes the attribute value information write-out unit 254 to write out the attribute information table already updated of the pieces of information in the processing target information table 246 into the external storage apparatus at a step S10.

As described above, the related information management unit 240 of FIG. 24 monitors the process that a user collectively executes to the information group, analyzes the process receiving the result of the monitoring and registers the result of the analysis into the attribute information table. Thereby, the relations between the pieces of information can be automatically extracted based on the process that the user collectively executes to an information group and the related information closely related to certain information can be obtained without searching for the related information by the user.

Furthermore, not only the pieces of information that are the target of the process but also pieces of information that are not the targets of the process at the process origin and the processing destination of the information group to which the user has collectively executed the process are checked and registered into the processing target information table 246, and the process by the user is analyzed based on this content of registration in the table.

Therefore, for not only the information group to which the user directly executes the process, including the information of which the relation with the information group that is the target of the process has made closer or weaker as a result of the collective processing by the user, the relations between those pieces of information can be automatically extracted and registered into attribute information tables and the related information closely related to certain information can be obtained without searching for the related information by the user.

Furthermore, by reading from the external storage apparatus or writing into the external storage apparatus the attribute information table registering the related information based on the analysis of the collective processing of the user, the related information extracted by analyzing the process that the user executed to the information group in the past can be reused and the related information closely related to certain information can be obtained efficiently without searching for the related information by the user.

FIG. 31 is a flowchart of the related information display process in Step S5 of FIG. 27. In this related information display process, when a user selects and designates a display of a piece of related information of certain information at a step S1, whether or not the attribute information table of the designated piece of information is present is checked at a step S2. If the attribute information table is present, whether or not the pieces of related information of the attribute information table are sorted and displayed in order of the degree of relation is checked at a step S3. If the sorting and displaying in order of the degree of relation is designated, the procedure advances to a step S4 and the degree of relation indicating the depth of relation with each piece of related information, from the attribute information table of the designated information. Finally, the pieces of related information are displayed under the designated sorting conditions and the display conditions at a step S5. As these sorting conditions that may be designated, the three (3) of the degree of relation as shown in the related information display rule 266 of FIG. 24, the date and time, and the name of the related information can be listed. Here, in the related information display process of FIG. 31, the information that is the target in displaying the related information is, for example, designated as follows.

(1) The related information corresponding to the information currently processed by a user is displayed. For example, in the case where Word (a registered trade mark) and Excel (a registered trademark) are used on Windows XP (a registered trademark) and edit is being executed on Word (a registered trade mark), the related information of a file edited on Word (a registered trade mark) is displayed.
(2) Of which piece of information the related information is displayed is designated by the user when the related information is displayed. For example, a file is designated through the file reference dialogue of Windows XP (a registered trademark) and the related information of the file is displayed.

FIG. 32 shows the attribute information table 250-1 of the information A that is the target of the related information display process of FIG. 26 together with a related information list 288 displayed based on the attribute information table 250-1. This related information list 288 is sorted and displayed, for example, by the latest date and time of registration of the attribute information table 250-1 of the information A in the ascending order. That is, display is executed in the related information list 288 sorting in order of the information E, D and B having newer date and time of registration. Surely, as the display of the related information, in addition to the above, needless to say that display by sorting by name of the related information or sorting by the degree of relation obtained by multiplying the attribute data from the number of times of document transition to the number of times of read-ins by predetermined weights and summing up the products may be possible.

FIG. 33 is a flowchart of the related information user registration process by the user attribute information registering unit 256 provided to the related information management unit 240 of FIG. 24. When registration of the related information of certain information is ordered by a user at a step S1, the user attribute information registering unit 256 determines whether or not the attribute information table of the information that is the target of the order is already read in, at a step S2. If the attribute information table has not been read in, the procedure advances to a step S3 and the user attribute information registering unit 256 orders the attribute information read-in unit 252 to read in the attribute information table of the designated information. Then, the user attribute information registering unit 256 checks whether or not the attribute information table of the designated information is present in the external storage apparatus at a step S4. If the attribute information table is not present, an attribute information table of the ordered information is newly created at Step S6. If the attribute information table is present, the attribute information table of the ordered information is read in from the external storage apparatus at a step S5. In the case where the attribute information table has been read in at the step S2, or has been read from the external storage apparatus or has been newly created at the steps S3 to S6, the related information designated by the user is registered into the attribute information table of the designated information at a step S7. Finally, the attribute information table already applied with the registration is written into the external storage apparatus 26 at a step S8.

FIG. 34 is a flowchart of the related information user deleting process by the user attribute information deleting unit 258 provided to the related information management unit 240 of FIG. 24. When deleting of the related information of certain information is ordered by a user at a step S1, the user attribute information deleting unit 258 determines whether or not the attribute information table of the ordered information is already read in, at a step S2. If the attribute information table is not present, the user attribute information deleting unit 258 orders the attribute information read-in unit 252 to read in the attribute information table of the ordered information at a step S3. Then, the user attribute information deleting unit 258 checks whether or not the attribute information table of the ordered information is present in the external storage apparatus at a step S4. If the attribute information table is not present, the process is ended. If the attribute information table is present, the attribute information table of the ordered information is read in from the external storage apparatus at a step S5. After the attribute information table of the ordered information has been read in at the step S2 or has been read from the external storage apparatus at steps S3 to S5, the related information is displayed in a list from the attribute information table of the ordered information at a step S6. Then, when the related information to be deleted is designated by the user at a step S7 and a confirm operation is executed by the user at a step S8, the related information designated is deleted from the attribute information table. Finally, the attribute information table already applied with the deletion is written into the external storage apparatus at a step S9.

Next, the details of the process for the process analyzing unit to create the processing target information table 246 based on the result of the process monitored by the monitor process unit 242 provided to the related information management unit 240 of FIG. 24 will be described. As shown in FIG. 35, in the case where a collective user process 292 such as copying, moving, deleting, creating links, etc. are executed to an information group 290 consisting of the information A, the information B, the information C and the information D, the creation process of the processing target information table 246 are classified into two (2) as follows depending on the execution method of the process of a computer.

(1) The case where the computer collectively processes pieces of information; and
(2) The case where the computer processes the pieces of information one by one.

FIG. 35 is an illustrative diagram of the case where a computer creates the processing target information table 246 by processing the pieces of information collectively. In FIG. 35, the case where a computer 294 collectively processes the pieces of information A to D of an information group 290 corresponds to, for example, a process 298 for evoking one (1) function that executes a process in a certain process 296 and designating all of the pieces of information A to D in the information group 290 as an argument of this function. At this time, the processing monitoring unit 242 monitors the evoking of the function that executes the process in the process 296 and, when the result of monitoring the evoking of the function is obtained, the processing monitoring unit 242 executes a registration process 302 for registering into the processing target information table 246 all of the pieces of information A to D of the information group 290 designated as the argument of this function.

FIG. 36 is an illustrative diagram of the processing target information table creating process for the case where a computer process each piece of information respectively for the information group 290 consisting of the pieces of information A to D. This case corresponds to a state where a computer 294 starts up each of threads 304-1 to 304-4 for each of the pieces of information A to D in a process 296, evokes functions that executes processes 306-1 to 306-4 in the threads and designates each piece of the information A to D in the information group 290 as the arguments of the functions. At this time, the processing monitoring unit 242 monitors the evocation of each of the functions respectively by each of the threads 304-1 to 304-4. In this manner, when evocation of function has been executed using the plurality of threads 304-1 to 304-4 in a process 296, it is necessary to determine up to which evocation of the function is a collective processing for the information group 290.

A flowchart of FIG. 37 is a flowchart of the processing target information table creation process for processing each piece of information respectively by the computer of FIG. 36. This flowchart shows the detailed content of the process of steps S1 to S4 in the related information automatic registration process. In FIG. 37, when a user executes a process to a certain information group at the step S1, the processing monitoring unit 242 assigns serial numbers (1, 2, . . . , N) to the processes obtained as the result of the monitoring and notifies of the numbers to the process analyzing unit 248 at the step S2. This step corresponds to assigning serial numbers (1, 2, . . . , N) to the evocation of the functions of the threads 304-1 to 304-4 in the example of FIG. 36. Then, the analysis process unit 248 creates processing target information table 246 and registers a certain piece of information in the information group that is the target of the process having a serial number 1 into the created table 246 at the step S3. Next, the process analyzing unit 248 analyzes each of processes having process numbers 2 to N and determines whether or not the process analyzing unit 248 will register the analyzed processes in the processing target information table 246. That is, at the step S4, whether the content of the process having a process number i that varies as i=2, 3, . . . , N and the processing destination having the process number 1 that has been registered are same is checked.

If they are same, whether or not the difference in time of the start of execution between the process number i and the process number 1 is within a predetermined time period is checked at a step S5. If the conditions of both of the steps S4 and S5 are satisfied, the piece of information in the information group that is the target of the process i is registered into the processing target information table at a step S6. If the conditions of both of the steps S4 and S5 are not satisfied, another processing target information table is created and the piece of information of the information group that is the target of process i is registered as another process. This processes at the steps S4 to S7 are repeated until the process i becomes a process N at the step S7.

Next, the details of the process of the process analyzing unit 248 of FIG. 19 for changing the attribute information table of the related information for the information that is the target of the user processes of copying, moving, deleting to the information group. FIG. 38 shows an example of the case where the information A is copied into information A′, the information B is moved into the information B′ between a folder 310 and a folder 312 and, in addition, the information C is deleted. Accompanied by these copying, moving or deleting of the pieces of information, the attribute information tables of the pieces of information are also similarly processes. That is, the attribute information table 250-1 of the information A is copied into an attribute information table 250-11 as the information A′. An attribute information table 250-2 of the information B is moved into an attribute information table 250-21 of the information B′. In addition, an attribute information table 250-3 of the information C is deleted.

FIGS. 39 and 40 together show a flowchart of an updating process for changing the attribute information tables of the pieces of information accompanied by the copying, moving, deleting of pieces of information as shown in FIG. 38. In FIGS. 39 and 40, when a user executes a process to a certain information group at a step S1, this execution is monitored by the monitor process unit 242 at a step S2 and the result of the monitoring is notified to the process analyzing unit 248. The process analyzing unit 248 checks which of copying, moving or deleting the content of the process is and determines how the attribute information tables of the pieces of information are processed according to the content of the process. If the process to the information group is determined to be “copying” at a step S3, the attribute information evoking unit 252 is evoked and the attribute information tables of the pieces of information in the information group are read in at a step S4. The information tables having been read are changed such that the tables correspond to the copied pieces of information of the information group and the changed tables are stored in the external storage apparatus by the attribute information write-in means 255 at a step S5. If the process to the information group is determined to be moving at a step S6, the attribute information evoking unit 252 is evoked and the attribute information tables of the pieces of information of the information group are read in from the external storage apparatus at a step S7. The attribute information tables having been read are changed such that the tables correspond to the moved pieces of information of the information group and the attribute information write-out unit 254 is read out and the changed tables are written into the external storage apparatus at a step S8. In addition, the attribute information tables of the pieces of information of the information group before the moving process is executed are deleted at a step S9. Furthermore, if the process to the information group is determined to be deleting at a step S10, the attribute information deleting unit 258 is evoked and the attribute information tables of the pieces of information of the information group are deleted at Step S10. In this manner, in the case where the position where information is stored is changed, the position where the attribute information table of the information is stored is also changed in response to the change of the position where the information is stored. Similarly, in the case where the position where information is stored has been changed, the related information about the information for which the storage position has been changed can be used without searching the information by the user him/herself.

FIGS. 41 and 42 are illustrative diagrams of the process for changing the attribute information table corresponding to pieces of related information of the information that is the target of the process by copying, moving and deleting of information as shown in FIG. 38. FIG. 41A shows the attribute information tables 250-1, 250-2 and 250-3 of the information A with which copying has been executed, the information B with which moving has been executed and the information C with which deleting has been executed of FIG. 38, and information Z is present in each of the tables as related information. This information Z is stored in a folder 320 together with information Y and the information Y has an attribute information table 250-5 and the information Z has an attribute information table 250-6. In this case, when copying of the information A, moving of the information B and deleting of the information C are executed, the attribute information table 250-6 of the information Z that is the related information for each of the information A, B and C is changed according to the content of the process to the information A, the information B and the information C that is the related information regarded from the viewpoint of the information Z. As shown in FIG. 42B, the change of the attribute information table 250-6 of the information Z is executed such that the information A′ at the copy destination is added to the attribute information table 250-6 of the information Z before the change according to copying 314 to obtain an attribute information table 250-61 of the information Z after the change, the information B′ at the move destination is registered into the attribute information table 250-61 after the change accompanied by moving 316 and, in addition, the information C in the original attribute information table 250-6 has been deleted from the attribute information table 250-61 after updating accompanied by deleting 318.

FIGS. 43 and 44 together show a flowchart of the updating process of the attribute information table of the related information in FIGS. 41 and 42. In FIGS. 43 and 44, when a user executes a process to a certain information group at a step S1, the processing monitoring unit 242 monitors the process to the information group and notifies of the result of the monitoring to the process analyzing unit 248 at a step S2. Then, the process analyzing unit 248 evokes the attribute information read-in unit 252 and causes the attribute information read-in unit 252 to read in the attribute information tables of pieces of information in the information group that are the targets of the process from the external storage apparatus at a step S3. In response to this, the attribute information read-in unit 252 reads the attribute information tables of the pieces of information from the external storage apparatus at a step S4. In the example of FIG. 41, this corresponds to the reading in of the attribute information tables 250-1 to 250-3 of the information A, B and C. Next, the process analyzing unit 248 checks pieces of related information in the attribute information tables corresponding to the pieces of information read from the external storage apparatus and orders the attribute information read-in unit 252 to read in the attribute information tables of the pieces of related information at a step S5. Receiving this order, the attribute information read-in unit 252 reads the attribute information tables of the pieces of related information from the external storage apparatus at a step S6. This corresponds to the checking of the related information Z and reading of the attribute information table 250-6 of the related information Z of FIG. 42. Next, the process analyzing unit 248 checks whether or not the pieces of information of the information group that is the target of the process are registered in the attribute information table of the related information at a step S7. In the example of FIG. 42, the information A, B and C of the information group that is the target of the process are registered in the attribute information table 250-6 of the information z and the above step corresponds to the checking of the registered information A, B and C. If the pieces of information that are the target of the process are registered in the attribute information table of the related information, whether or not the process to the information group is copying is checked at a step S8. If the process is copying, the copied pieces of information in the information group are additionally registered into the attribute information table of the related information at a step S9. This corresponds to the additional registration of the information A′ by the copying in the new attribute information table 250-61 of the information Z of FIG. 42. Then, when the process to the information group is determined to be “moving” at a step S10, the pieces of information in the information group that is the target of the process, registered in the attribute information table of the related information are changed such that the pieces of information correspond to the pieces of information in the information group that have been moved, at a step S11. This corresponds to the registration of the information B′ by the moving, into the new attribute information table 250-61 of the information Z in the example of FIG. 42. Furthermore, when the process to the information group is determined to be deleting at a step 512, pieces of information in the information group that is the target of the process, registered in the attribute information table of the related information are deleted at a step S13. This corresponds to the deleting of the information C to the attribute information table 250-6 of the information Z in the example of FIG. 42. When such a changing process to the attribute information table of the related information corresponding to the pieces of information in the information group that is the target of the process, according to Step S7 to S13, has been finished, the process analyzing unit 248 evokes the attribute information write-in unit 254 and orders and causes the attribute information write-in unit 254 to write the changed attribute information table of the related information into the external storage apparatus at a step S14. In the case where the process of the user to the information group is monitored and the position where the information is stored in changed from the analysis of the monitoring as described above, the related information of the information that is the target of the process is checked by referring to the attribute information table of the information and, if pieces of information that are the targets of the process are present in the attribute information table of the related information, the attribute information table of the related information is changed according to the state of the change of the position where the information that is the target of the process is stored. Therefore, in addition to the change in the attribute information table of the information that is the target of the process by the user, as to the attribute information table of the related information, change is also automatically executed corresponding to the process of the user, and as to the related information not contained in the process origin and the processing destination that are the targets of the process, the result of the change corresponding to the process of the user is reflected to the attribute information table of the related information, and the information not contained in the process origin and the processing destination can be appropriately accessed as the related information when the user processes certain information later.

FIG. 45 is an illustrative diagram of the case where the related information management of the present invention is adapted for a network. This related information management of the present invention adapted for a network is connected with a plurality of user apparatuses 324-1 to 324-3 through a network 326 such as the Internet, etc. and is provided with a related information management server 328 in order to realize the related information management of the present invention on a network. The related information management server 328 is provided with one (1) or both of the functions of the related information management unit 40 shown in the first embodiment of FIGS. 2 and 3 and the related information management unit 240 shown in the embodiment of FIGS. 23 and 24, and monitors the process by a user to the pieces of information respectively at the user apparatus 324-1 to 324-3 or an information group connected with the network 326 similarly to the process by the user of the user interface 28 or 23 of FIGS. 2 and 3 and the user interface 280 of FIG. 24, related information is extracted by analyzing the result of the monitoring and, when the same information is processed next time, the related information of the same information is caused to be displayed and made available for a user to access.

FIG. 46 is an illustrative diagram for the case where a process by a user, that is the target of monitoring is executed as an operation to a shortcut that is virtual information, in the related information management of the present invention.

In FIG. 46, on the process-by-apparatus 332 side, the an actual body 336 of a file “A” is provided by a folder 334 and, on the process-by-user 330 side, a shortcut 340 of the file A is provided by a folder 338-1. When, for example, a user operation 342 such as access, copying, moving or deleting as a user process to such a shortcut 340 that is the virtual information is executed, the processing monitoring unit 42 of FIGS. 2 and 3 or the processing monitoring unit 242 of FIGS. 23 and 24 monitors the process by this user operation 342 and, based on the result of the monitoring, a process of change of the attribute information table of the actual body of the file A is executed as a related information management unit 344. When a process of referring 346 of the related information of the shortcut of the file A is executed looking at the display of the related information related to certain information displayed by the related information display unit 60 of FIGS. 2 and 3 or the related information display unit 260 of FIGS. 23 and 24, like a folder 338-2 on the right, a process 348 for display for reference the related information of the actual body of the file A is executed receiving an access to the shortcut 340 of the file A. That is, as to a process by a user to a shortcut that is the actual body of virtual information or a process of reference for referring to the related information, similarly to the embodiments of FIGS. 2 and 3 and FIGS. 23 and 24, the processes are monitored as one (1) process and, based on the result of the monitoring, creation of attribute information and display of the related information utilizing the attribute information can be executed.

The above embodiment takes an example of the related information management process for the case where a user accesses a file. However, the case where a user accesses a WWW home page can be applied completely similarly. Surely, the case where a user accesses both of a file and a WWW home page can be applied similarly.

Furthermore, the above embodiment takes an example of the case where the program of the related information management of the present invention is installed in the host computer and is executed. However, needless to say that an appropriate apparatus by a CPU, on which a program is executed such as a personal computer or a PAD is included.

Moreover, the program that realizes the related information management according to the present invention operates as an application program in the background linked with, for example, Word (a registered trademark) or Excel (a registered trademark) of Microsoft and, through file accesses or accesses to WWW home pages by the user, automatically creates the related information for certain information in the form of an attribute information table and enables display of the related information and accesses to the related information.

Furthermore, the present invention encompasses any appropriate modifications without impairing the object and advantages thereof and is not restricted by the numerical values indicated in the above embodiments.

### INDUSTRIAL APPLICABILITY

### Registration of Related Information Based on User Processing of Single Information

As set forth herein above, according to the present invention, based on a process by a user in creation or edit of a document or an image by the user, related information related to certain information is automatically extracted and registered as the related information. Therefore, the user does not need to select the related information intentionally. Moreover, the related information is extracted based on the process by the user. Therefore, information regarded from the viewpoint of the user as being closely related can be automatically extracted.

Moreover, the extracted related information is recorded in, for example, an external storage apparatus and is updated again during the next process by the user. Thereby, closely related information including the related information registered in the past can be accessed easily and appropriately.

As to the display of the related information automatically extracted, because plural pieces of related information are displayed being sorted by the degree of relation, date of update, the name of information, a user can easily recognize the depth of the degree of relation of the displayed pieces of related information and can access more accurately the closely related information.

Moreover, registration and deleting of related information can be directly executed by a user when necessary and the usability of the related information that is the target of the relation can be more improved.

Furthermore, in not only the case where a process and a piece of information correspond to each other one to one but also the case where a process and a piece of information do not correspond to each other one to one as the case of a multi-thread OS, related information can be automatically created appropriately by the attribute information table constructed for each piece of information and can be made available for a user to use efficiently.

### (Registration of Related Information Based on User Processing of Information Group)

In addition, in the present invention, when a user collectively executes processes by the user such as copying, moving and deleting to an information group including plural pieces of information, the related information of the pieces of information that are the targets of the processes in the information group is automatically extracted and registered as attribute information and, when the same information is processed later, the extracted related information can be displayed and the user can selectively access the displayed related information and does not need to select the related information in the collective processing to the information group. Furthermore, the related information is automatically extracted based on the process by the user. Therefore, information regarded from the viewpoint of the user as being closely related can be accurately extracted and a user can use efficiently the automatically extracted related information without searching the related information by him/herself.

In addition, as to the collective processing by a user to an information group, for not only the information that is the target of a direct process but also the pieces of information that are not the target of the process at the process origin and the processing destination, addition or deletion can be executed utilizing the related information according to the degree of relation with the process by the user after extraction and use of closely related information accompanied by a process by the user by automatic production can be realized next time.

Yet furthermore, similarly, in the case where the positions of pieces of information have been changed by a process such as copying, moving or deleting executed by a user to an information group, the content of the attribute information registered for the pieces of information is changed according to the content of the process and the user can refer to the related information based on the attribute information when the user processes same information even after the execution of the process, just as before the execution of the process.

1. A related information management method comprising:
a processing monitoring step of a processing monitoring unit monitoring user collective processing of an information group;
a first processing analyzing step of a first processing analyzing unit creating a processing target information table that registers pieces of information to be processed by the user in an information group and the content of the processing from the result of the monitoring of the processing monitoring process;
a second processing analyzing step of a second processing analyzing unit analyzing what processing has been executed on the pieces of information registered in the processing target information table, to extract relations between pieces of information;
a third processing analyzing step of a third processing analyzing unit creating an attribute information table that registers relations between the extracted pieces of information;
a related information display step of a related information display unit displaying one (1) or plural pieces of related information based on the attribute information table; and
a related information accessing step of a related information accessing unit accessing pieces of information selected from among the displayed pieces of related information.

2. A related information management method according to claim 1, further comprising:
a processing target information collecting step of checking pieces of non-target information that are not the targets of the process included in an information group of a process origin or a processing destination that are to be processed by the user, and registering the non-target pieces of information in the processing target information table, wherein
the third processing analyzing step includes extracting the relations between the non-target pieces of information of the process origin and the processing destination that are registered in the processing target information table and the pieces of information processed by the user, to update the attribute information table based on the extracted relations.

3. A related information management method according to claim 1, wherein the third processing analyzing step includes copying, moving or deleting the attribute information table corresponding to the pieces of information registered in the processing target information table, in response to the user processing.

4. A related information management method according to claim 1, wherein the third processing analyzing step includes checking the attribute information table of a piece of related information registered in an attribute information table of the pieces of information in the information group that is to be processed by the user, and changing if pieces of information to be processed by the user are registered in the attribute information table of the pieces of related information, the content of registration of the pieces of information to be processed, registered in the attribute information table of the related information, depending on the content of the processing.

5. A related information management method according to claim 1, wherein the second processing monitoring step includes determining whether or not the processing is a user collective processing of the information group from at least one (1) of the processing destination of the pieces of information of the information group, and the difference in the time to start up processings of the pieces of information of the information group.

6. A related information management method according to claim 1, wherein the information to be processed by the user includes a file, a folder, a www home page or a link of a file.

7. A related information management method according to claim 1, wherein the result of the analyzing registered in the attribute information table includes at least any one (1) of copying, moving, deleting, creation of a link, deleting of a link and drag-and-drop of information.

8. A related information management method according to claim 1, wherein the related information display step includes calculating degrees of relations indicating the depths of the relation of plural pieces of related information while referring to the attribute information table, to display in juxtaposition the plural pieces of related information in order of the degrees of relation.

9. A program operable to drive a computer to execute:
a processing monitoring step of monitoring user collective processing of an information group;
a first processing analyzing step of creating a processing target information table that registers pieces of information to be processed by the user in an information group and the content of the processing from the result of the monitoring of the processing monitoring process;
a second processing analyzing step of analyzing what processing has been executed on the pieces of information registered in the processing target information table, to extract relations between pieces of information;
a third processing analyzing step of creating an attribute information table that registers relations between the extracted pieces of information;
a related information display step of displaying one (1) or plural pieces of related information based on the attribute information table; and
a related information accessing step of accessing pieces of information selected from among the displayed pieces of related information.

10. A program according to claim 9, operable to further drive the computer to execute:
a processing target information collecting step of checking pieces of non-target information that are not the targets of the process included in an information group of a process origin or a processing destination that are to be processed by the user, and registering the non-target pieces of information in the processing target information table, wherein
the third processing analyzing step includes extracting the relations between the non-target pieces of information of the process origin and the processing destination that are registered in the processing target information table and the pieces of information processed by the user, to update the attribute information table based on the extracted relations.

11. A program according to claim 9, wherein the third processing analyzing step includes copying, moving or deleting the attribute information table corresponding to the pieces of information registered in the processing target information table, in response to the user processing.

12. A program according to claim 9, wherein the third processing analyzing step includes checking the attribute information table of a piece of related information registered in an attribute information table of the pieces of information in the information group that is to be processed by the user, and changing if pieces of information to be processed by the user are registered in the attribute information table of the pieces of related information, the content of registration of the pieces of information to be processed, registered in the attribute information table of the related information, depending on the content of the processing.

13. A program according to claim 9, wherein the second processing monitoring step includes determining whether or not the processing is a user collective processing of the information group from at least one (1) of the processing destination of the pieces of information of the information group, and the difference in the time to start up processings of the pieces of information of the information group.

14. A program according to claim 9, wherein the information to be processed by the user includes a file, a folder, a www home page or a link of a file.

15. A program according to claim 9, wherein the result of the analyzing registered in the attribute information table includes at least any one (1) of copying, moving, deleting, creation of a link, deleting of a link and drag-and-drop of information.

16. A program according to claim 9, wherein the related information display step includes calculating degrees of relations indicating the depths of the relation of plural pieces of related information while referring to the attribute information table, to display in juxtaposition the plural pieces of related information in order of the degrees of relation.

17. A related information management apparatus comprising:
a processing monitoring unit operable to monitor user collective processing of an information group;
a first processing analyzing unit operable to create a processing target information table that registers pieces of information to be processed by the user in an information group and the content of the processing from the result of the monitoring of the processing monitoring process;
a second processing analyzing unit operable to analyze what processing has been executed on the pieces of information registered in the processing target information table, to extract relations between pieces of information;
a third processing analyzing unit operable to create an attribute information table that registers relations between the extracted pieces of information;
a related information display unit operable to display one (1) or plural pieces of related information based on the attribute information table; and
a related information accessing unit operable to access pieces of information selected from among the displayed pieces of related information.
